(19) United States
(12) Patent Application Publication
(10) Pub. No.: US 2010/0242715 A1
(43) Pub. Date: Sep. 30, 2010

(54) GLASS-CERAMIC MATERIALS HAVING A PREDOMINANT SPINEL-GROUP CRYSTAL PHASE

(75) Inventors: Alexander Raichel, Rishon LeZion (IL); Arthur Raichel, Rishon LeZion (IL); Svetlana Raichel, Rishon LeZion (IL)

Correspondence Address: MARTIN D. MOYNIHAN d/b/a PRTSI, INC., P.O. BOX 16446, ARLINGTON, VA, 22215, US

(73) Assignee: D&D SALOMON INVESTMENT LTD., Herzlia (IL)

(21) Appl. No.: 12/304,269

(22) PCT Filed: Jun. 12, 2007
(86) PCT No.: PCT/IL2007/000705

§ 371 Date: Nov. 9, 2009

Related U.S. Application Data
(60) Provisional application No. 60/812,988, filed on Jun. 13, 2006.

(51) Int. Cl. F41H 5/02; C03C 10/02

(52) U.S. Cl. 89/36.02; 501/10; 89/903

(57) ABSTRACT

Disclosed are glass-ceramics having predominantly Spinel-group crystal phases and methods of making the glass-ceramics. Disclosed are glass-ceramics harder than 10 GPa (Vickers) and methods of making the glass-ceramic. Disclosed are articles of manufacture made of the glass-ceramics. Disclosed is the use of the glass-ceramics in armor and related applications.

### FIELD AND BACKGROUND OF THE INVENTION

The present invention relates to the field of materials and specifically to novel glass-ceramic materials including a predominant Spinel-group crystal phase, methods of making the same and articles of manufacture made of the same. The present invention also relates to the field of ballistic protection and specifically to methods and articles for protecting an object from kinetic threats using a glass-ceramic component and methods for manufacturing armor and related article.

A sensitive object is often protected by armor interposed between the sensitive object and an approaching kinetic threat. As a result the kinetic threat impacts with the armor instead of with the sensitive object. The armor is configured to neutralize the kinetic threat by one or more methods such as deflection of the kinetic threat, destruction/deformation of the kinetic threat and dissipation of the kinetic energy of the kinetic threat. In the art, known mechanisms for dissipating the kinetic energy of the kinetic threat include deformation of the kinetic threat, deformation of the armor, absorption of the kinetic energy of the kinetic threat and distribution of the kinetic energy over a large area.

Different types of materials are known for use as components of armor.

Metal armor provide excellent protection from kinetic threats, is cheap and relatively easy to produce from alloys of aluminum, cobalt, titanium and iron. A kinetic threat impacting metal armor is deflected or deformed and any kinetic energy deposited in the armor is dissipated by elastic and inelastic deformation of the armor. The weight of metal armor is such that providing sufficient protection against common kinetic threats is often impractical.

Ceramic armor provides a high level of protection from kinetic threats and is light in weight when compared to equivalent metal armor. Ceramic materials often used in armor are monolithic ceramics such as Al₂O₃, B₄C, SiC, TiB₂ and AlN. Monolithic ceramics are generally highly pure powders of essentially inorganic nonmetallic ionically or covalently bonded substances sintered at high temperatures to make a monolithic block of material. As ceramics are made of highly pure substances and require processing at very high temperatures, ceramic armors are relatively expensive.

A kinetic threat impacting ceramic armor is deformed and the kinetic energy dissipated by inelastic deformation of the armor through a combination of a pulverization energy mechanism and a fracture energy mechanism. In the pulverization energy mechanism, a comminution zone of pulverized ceramic in the shape of a conoid emerging from the impact point is produced. In the fracture energy mechanism, kinetic energy is absorbed by the ceramic plate, distributed throughout the plate and subsequently expended by the shattering of the ceramic plate itself along many radial and circumferential cracks. A liner, usually of textile or metal armor located behind the ceramic, absorbs and dissipates any residual kinetic energy of fragments of the ceramic armor and of the kinetic threat.

Since the kinetic energy of an impacting kinetic threat is dissipated by shattering of the ceramic plate, armor including a ceramic plate as a component is generally useful for protecting an object only against impact from a single kinetic threat. Due to the extensive shattering of the ceramic plate, subsequent impacts have a statistically significant chance to impact on a crack and penetrate with little or no resistance. Further, the shards of the ceramic plate are relatively small and have little mass: the small size means that there only a few bonds are available for dissipation of energy from subsequent kinetic threat impacting on such a shard and that such a shard may be pushed through by an impacting kinetic threat into the sensitive object being protected.

Ceramic-matrix composites are sometimes used instead of monolithic ceramics for protecting objects from kinetic threats. Suitable ceramic-matrix composites include fiber-reinforced materials such as Al₂O₃/SiC and Al₂O₃/C, ceramic/particulates such as TiB₂/B₄C and TiB₂/SiC and cermets such as SiC/Al, TiC/Ni and B₄C/Al. The primary advantage of ceramic-matrix composites compared to monolithic ceramics is improved mechanical properties especially increased toughness and a reduced flaw sensitivity. The additional phase provides modes of energy dissipation in addition to shattering and crack-propagation, e.g., delamination of the ceramic phase from the additional phase and by friction as the additional phase moves past the ceramic phase. Further, in fiber-reinforced materials the additional phase retains structural integrity of the structure across a crack. Armor components made of ceramic-matrix composites are generally prohibitively expensive to manufacture and process.

Glass-ceramics are polycrystalline compositions comprising one or more crystalline phases uniformly distributed inside a glass phase formed by devitrification of a glass composition. Glass-ceramics generally have high strength, high thermal conductivity, low thermal expansion, are non-porous, are impermeable to gases and are resistant to thermal shock.

Glass-ceramics are formed by devitrification of a glass composition, usually in the presence of a nucleating agent. The glass composition is melted at a temperature typically above 1300° C. to form a homogenous molten glass composition. The glass is then maintained for a period of time in a temperature regime generally lower then the melting temperature to allow devitrification, that is, a portion of the glass composition crystallizes while the remainder remains in an amorphous glass state. Ultimately produced are stoichiometrically accurate crystal phases embedded in a glass phase.

An important advantage of glass-ceramics over other monolithic ceramics and ceramic-matrix composites is a relatively low cost of production. Glass-ceramics are made by melting a glass composition at a temperature that is low in comparison to temperatures required for sintering ceramics. Thus, the cost of energy and the cost of vessels necessary for producing glass-ceramics are relatively low in comparison to those of ceramics. Further, in contrast with ceramics which are produced from highly pure components in exact proportions, glass-ceramics are often fabricated from cheap impure starting materials such as ores, sand or industrial slag and ash, see for example, Russian Patent RU 2052400, English Patent GB 1,459,178, as well as U.S. Pat. No. 4,191,546, U.S. Pat. No. 5,521,132 and U.S. Pat. No. 5,935,885.

Generally, the physical properties of glass-ceramics are dependent on a number of factors. A first factor is the identity of the glass phase and the crystal phase or phases. A second factor is the ratio of crystalline phase to amorphous phase: generally, the higher the proportion of crystalline phase, the harder and less frangible is the product. A third factor is crystal size. The smaller the crystals, the more difficult it is for cracks to spread throughout a glass-ceramic structure, making such a structure more robust. Generally, a crystal size smaller than 1 micron is considered as being appropriate for most implementations.

The crystal size and crystal content in a glass-ceramic are dependent on at least two parameters of the devitrification process: the rate of formation of nucleation centers (which occurs at a maximal rate at some temperature Tₘₐₓ₁) and the rate of crystal growth (which occurs at a maximal rate at some temperature Tₘₐₓ₂, where Tₘₐₓ₂>Tₘₐₓ₁). Ideally, once Tₘₐₓ₁ and Tₘₐₓ₂ are known, a crystallization regime can be formulated, see FIG. 1. On a practical level, however, it is difficult to accurately expose a glass to the theoretical Tₘₐₓ₁ and Tₘₐₓ₂ in a devitrification kiln, a problem aggravated by the fact that the actual oven temperatures fluctuate depending on many conditions.

As a compromise, in the art it is known to use either a one-stage devitrification regime or a two-stage devitrification regime when producing a glass-ceramic from a molten glass composition.

In a one-stage devitrification regime, the molten glass composition is maintained in an environment set at a single temperature midway between Tₘₐₓ₁ and Tₘₐₓ₂, the single temperature giving an acceptable compromise of properties.

In a two-stage devitrification regime, the molten glass composition is maintained in an environment set at a first temperature, the first temperature being roughly Tₘₐₓ₁. After a certain amount of time deemed sufficient for formation of enough nucleation centers, the temperature setting of the oven is raised to a second higher temperature, the second temperature being roughly Tₘₐₓ₂.

A glass precursor composition from which a glass-ceramic is made generally includes between about 30% and 75% by weight SiO₂, between about 7% and 35% by weight Al₂O₃ and an additional component that acts as a nucleation agent. Typical nucleation agents include CeO₂, Cr₂O₃, MnO₂, P₂O₅, SnO₂, TiO₂, V₂O₅, ZnO and ZrO₂ as well as anions such as F—, S²⁻ and SO₄²⁻. Often fluxing agents are added to a glass precursor composition. Typical fluxing agents include CaO, K₂O, Na₂O, Li₂O, PbO, MgO, MnO and B₂O₃. Often fining agents are added to a glass precursor composition. Typical fining agents include As₂O₃ and Sb₂O₃. Other components typically found in glass precursor compositions include Fe₂O₃, BaO, ZnO, Mn₃O₄, NiO, CoO and oxides of Ge, Ga, Se, Nb and Sb.

It is known in the art to use glass-ceramics for protection from kinetic threats.

In U.S. Pat. No. 4,473,653 is taught the use of a glass-ceramic as armor. A composition of U.S. Pat. No. 4,473,653 includes Li₂O (9.5%-15% by weight), Al₂O₃ (1.0%-6.0% by weight), SiO₂ (78.5%-84.5% by weight) and K₂O (1.0%-4.0% by weight) as lithium disilicate, cristobalite and spinel crystals in a glassy matrix, where the essential nucleation agent is a combination of TiO₂, ZrO₂ and SnO₂ in a ratio of 3:2:1. A preferred glass-ceramic of U.S. Pat. No. 4,473,653 is reported to have a hardness of between 4.95 and 6.23 GPa, a density of 2.4-2.5 g cm⁻³ and a coefficient of thermal expansion (TCLE) of greater than 100×10⁻⁷° C.⁻¹. The maximal TiO₂ content in a composition of U.S. Pat. No. 4,473,653 is 3%. The impact of a single kinetic threat (7.62 mm copper jacketed bullet at 152 cm with a muzzle velocity of 777 m sec⁻¹) on a 21.7 mm thick glass-ceramic plate of U.S. Pat. No. 4,473,653 shatters the plate.

In U.S. Pat. No. 5,060,553 is taught the use of sintered or hot-pressed glass-ceramic plates for use as armor. Glass-ceramics suitable for armor applications according to the teachings of U.S. Pat. No. 5,060,553 are silicates of lithium zinc, lithium aluminum, lithium zinc aluminum, lithium magnesium, lithium magnesium aluminum, magnesium aluminum, calcium magnesium aluminum, magnesium zinc, calcium magnesium zinc, zinc aluminum, barium silicate and both calcium phosphates and calcium silica phosphates. In a first embodiment of the teachings of U.S. Pat. No. 5,060,553 is disclosed a composition that includes, in addition to other components, 7% by weight Al₂O₃ and 72% by weight SiO₂ having a density of 2.45 g cm⁻³, a hardness of 5.7 GPa (580 Knoop), and an elastic modulus of 104 GPa. In a second embodiment of the teachings of U.S. Pat. No. 5,060,553 is disclosed a composition that includes, in addition to other components, 13% by weight Al₂O₃ and 71% by weight SiO₂ having a density of 2.4 g cm⁻³, a hardness of 5.25 GPa (535 Knoop), and an elastic modulus of 88 GPa. In a third embodiment of the teachings of U.S. Pat. No. 5,060,553 is disclosed a composition that includes, in addition to other components, 33% by weight Al₂O₃ and 36% by weight SiO₂ having a density of 3.1 g cm⁻³, a hardness of 10.8 GPa (1100 Knoop), and an elastic modulus of 150 GPa. In a fourth embodiment of the teachings of U.S. Pat. No. 5,060,553 is disclosed a composition that includes, in addition to other components, 26% by weight Al₂O₃ and 50% by weight SiO₂ having a density of 2.7 g cm⁻³, a hardness of 6.0 GPa (608 Knoop) and an elastic modulus of 105 GPa. Although a mechanism for energy dissipation of an impacting kinetic threat is discussed, no report as to the actual ability of the compositions in neutralizing kinetic threats is presented.

In PCT Patent Application IL2005/000577 published as WO2005/119163 and in U.S. patent application Ser. No. 10/928,723 published as US 2005/0119104 both of the inventor are taught glass-ceramic compositions including an Anorthite phase for use in protecting against kinetic threats, the compositions including SiO₂, Al₂O₃, CaO and TiO₂. In an embodiment the glass-ceramic composition is reported as having a density of 1.7 g cm⁻³, a hardness of up to 10 GPa and an elastic modulus of 100 GPa. 1 cm thick plates of the glass-ceramic compositions are shown to be effective in neutralizing impact of multiple consecutive kinetic threats including six M-80 bullets impacting at about 850 m sec⁻¹ or six SS-109 bullets impacting at about 950 m sec⁻¹. Importantly, the glass-ceramic plates did not shatter and are therefore useful in protecting an object from multiple kinetic threats.

In the art it is accepted that a material used for neutralizing a kinetic threat is preferably harder than the kinetic threat. When the kinetic threat impacts a harder material, the kinetic threat itself deforms and fragments, a process that dissipates kinetic energy. Further, fragmentation of an impacting kinetic threat reduces the chance of ricochet or follow-through penetration. Thus, despite the efficacy of the glass-ceramics taught in PCT Patent Application IL2005/000577 and in U.S. patent application Ser. No. 10/928,723 in neutralizing kinetic threats, it is believed that providing glass-ceramics that are harder than those known in the art would allow for more effective glass-ceramic armor.

It would be advantageous to have glass-ceramics harder than those known in the art that would potentially be useful in providing protection from kinetic threats. It would be advantageous that such glass-ceramics be relatively cheap so it would be economical to produce consumer products there from.

### SUMMARY OF THE INVENTION

At least some of the objectives above are achieved by embodiments of the present invention.

According to the teachings of the present invention there is provided a glass-ceramic comprising a glass phase and at least one crystal phase, the at least one crystal phase predominantly comprising Spinel-group crystal phases, the Spinel group crystal phases having the formula XO—Z₂O₃ where X is a divalent metal ion and Z is a trivalent metal ion. Embodiments of the glass ceramic of the present invention are relatively hard, having a bulk hardness of at least about 11, at least about 12, at least about 13, at least about 14, at least about 15 and even at least about 16 GPa (Vickers).

According to the teachings of the present invention there is also provided an object comprising a glass-ceramic having a bulk hardness (as opposed to a film hardness) of at least about 11, at least about 12, at least about 13, at least about 14, at least about 15 and even at least about 16 GPa (Vickers). In embodiments, the glass-ceramic comprises divalent metal oxides XO and trivalent metal oxides Z₂O₃, in embodiments at least about 50% by weight XO and Z₂O₃. In embodiments, the glass-ceramic comprises a glass phase and at least one crystal phase, the at least one crystal phase predominantly comprising Spinel-group crystal phases, the Spinel group crystal phases having the formula XO—Z₂O₃.

In embodiments, at least one of the Spinel-group crystal phase is a member of the Gahnite-Spinel series (ZnOAl₂O₃—MgOAl₂O₃), the Hercinyte-Spinel series (FeOAl₂O₃—MgOAl₂O₃), the Chromite-Magnesiochromite Series (Fe—OCr₂O₃—(Mg,Fe)O(Al,Cr)₂O₃), the Magnesiochromite-Spinel Series (Mg,Fe)O(Al,Cr)₂O₃—MgOAl₂O₃), the Chromite-Hercynite Series (Fe—OCr₂O₃—FeOAl₂O₃), the Gahnite-Hercynite Series (ZnOAl₂O₃—FeOAl₂O₃).

In embodiments the Spinel-group crystal phases include at least one Spinel group crystal phase selected from the group consisting of Spinel (MgO—Al₂O₃), Gahnite (ZnO—Al₂O₃), Galaxite ((Mn,Fe,Mg)O—(Al,Fe)₂O₃), Galaxite ((Mn,Mg)O—Al₂O₃), Galaxite (MnO—Al₂O₃), Galaxite (MgO—(Al,Fe)₂O₃), Hercinyte (FeO—Al₂O₃), Magnetite (FeO—Fe₂O₃), Chromite (FeO—Cr₂O₃), Franklinite ((Zn,Fe)O—Mn₂O₃) and Magnesiochromite ((Mg,Fe)O—(Al,Cr)₂O₃)

In embodiments, the Spinel-group crystal phases comprises at least two different Spinel-group crystal phases.

In embodiments, the Spinel-group crystal phases comprise a predominant Spinel-group crystal phase. In embodiments, the predominant Spinel-group crystal phase is selected from the group consisting of Spinel (MgO—Al₂O₃), Magnesiochromite-Spinel Series (Mg,Fe)O(Al,Cr)₂O₃—MgOAl₂O₃), Galaxite ((Mn,Fe,Mg)O—(Al,Fe)₂O₃), Galaxite ((Mn,Mg)O—Al₂O₃), Galaxite (MnO—Al₂O₃), Gahnite (ZnO—Al₂O₃), Gahnite-Spinel series ((Zn,Mg)O—Al₂O₃) and mixtures thereof.

In embodiments, X is selected from the group of divalent metal ions consisting of Mg²⁺, Fe²⁺, Ni²⁺, Mn²⁺, Zn²⁺ and mixtures thereof.

In embodiments, Z is selected from the group of trivalent metal ions consisting of Al³⁺, Fe³⁺, Cr^{3÷}, Mn³⁺ and mixtures thereof. In embodiments, Z comprises Al³⁺.

In embodiments, the glass-ceramic, comprises at least about 4% by weight XO. In embodiments, the glass-ceramic, comprises no more than about 40% by weight XO.

In embodiments, the glass-ceramic comprises at least about 4% by weight MgO as at least a portion of the XO. In embodiments, the glass-ceramic comprises no more than about 30% by weight MgO as at least a portion of the XO.

In embodiments, the glass-ceramic comprises at least about 4% by weight MnO as at least a portion of the XO. In embodiments, the glass-ceramic comprises no more than about 30% by weight MnO as at least a portion of the XO.

In embodiments, the glass-ceramic comprises at least about 4% by weight ZnO as at least a portion of the XO. In embodiments, the glass-ceramic comprises no more than about 30% by weight ZnO as at least a portion of the XO.

In embodiments, the glass-ceramic, comprises at least about 10% by weight Z₂O₃. In embodiments, the glass-ceramic, comprises no more than about 45% by weight Z₂O₃.

In embodiments, the glass-ceramic comprises at least about 10% by weight Al₂O₃ as at least a portion of the Z₂O₃. In embodiments, the glass-ceramic comprises no more than about 45% by weight Al₂O₃ as at least a portion of the Z₂O₃.

In embodiments, Al₂O₃ comprises as at least about 50%, at least about 66% and even at least about 75% by weight of total Z₂O₃ in the glass-ceramic.

In embodiments, the glass-ceramic comprises TiO₂. In embodiments, the glass-ceramic comprises a TiO₂ crystal phase. In embodiments, the glass-ceramic comprises at least about 1%, at least about 2%, at least about 4%, at least about 6% and even at least about 8% by weight TiO₂. In embodiments, the glass-ceramic comprises no more than about 24% by weight TiO₂.

In embodiments, the glass-ceramic comprises SiO₂. In embodiments, the glass-ceramic comprises at least about 30% by weight SiO₂. In embodiments, the glass-ceramic comprises no more than about 70% by weight SiO₂. In embodiments, the glass-ceramic includes a glass phase comprising SiO₂. In embodiments, the glass-ceramic includes a glass phase comprising predominantly SiO₂.

In embodiments, a glass-ceramic of the present invention comprises between about 35% and about 48% by weight SiO₂; between about 12% and about 34% by weight Al₂O₃; between about 9% and about 17% by weight MgO; and between about 10% and about 18% by weight TiO₂. In embodiments the crystal phase or phases of such a glass-ceramic are predominantly Spinel-group crystal phases. In embodiments, such a glass-ceramic has a predominant Spinel crystal phase.

In embodiments, a glass-ceramic of the present invention comprises between about 41% and about 47% by weight SiO₂; between about 15% and about 21% by weight Al₂O₃; between about 6% and about 12% by weight MgO; between about 15% and about 21% by weight ZnO; and between about 9% and about 13% by weight TiO₂. In embodiments the crystal phase or phases of such a glass-ceramic are predominantly Spinel-group crystal phases. In embodiments, such a glass-ceramic has a predominant Gahnite-Spinel series crystal phase.

In embodiments, a glass-ceramic of the present invention comprises between about 41% and about 47% by weight SiO₂; between about 16% and about 20% by weight Al₂O₃; between about 8% and about 11% by weight MgO; between about 16% and about 22% by weight MnO; and between about 9% and about 15% by weight TiO₂. In embodiments the crystal phase or phases of such a glass-ceramic are predominantly Spinel-group crystal phases. In embodiments, such a glass-ceramic has a predominant Galaxite crystal phase.

According to the teachings of the present there is also provided a method of producing a glass-ceramic comprising: a. providing a glass composition comprising at least one divalent oxide XO and at least one trivalent oxide Z₂O₃; and b. devitrifying the glass composition under conditions which lead to the formation of at least one crystal phase suspended in a glass phase so as to constitute the glass-ceramic, the at least one crystal phase predominantly comprising Spinel-group crystal phases, the Spinel group crystal phases having the formula XO—Z₂O₃ where X is a divalent metal ion and Z is a trivalent metal ion, thereby producing the glass-ceramic.

In embodiments, the devitrifying includes holding the glass composition at temperatures higher than room temperature for a period of time sufficient to allow crystallization of at least some of the glass composition to form the Spinel-group crystal phases.

In embodiments, the devitrifying comprises: i. holding the glass composition in an environment (for example in an oven) maintained at a temperature T1 to provide an incipient glass-ceramic; and ii. subsequent to i, holding the incipient glass-ceramic in an environment maintained at a temperature T2 substantially higher than T1 thereby leading to formation of the Spinel-group crystal phases. In embodiments, T2 is substantially higher than T1, for example, T2 is at least about 50° C., at least about 100° C., at least about 150° C. and even at least about 200° C. higher than T1.

In embodiments, the devitrifying further comprises: iii. subsequent to ii, holding the incipient glass-ceramic in an environment maintained at a temperature T3 substantially lower than T2; and iv. subsequent to iii, holding the incipient glass-ceramic in an environment maintained at a temperature T4 substantially higher than T3. In embodiments T3 is substantially equal to T1, for example T3=T1±50° C. or even T3=T1±25° C. In embodiments T4 is substantially equal to T2, for example T4=T2±50° C. or even T4=T2±25° C. In embodiments, T4 is substantially higher than T2, for example, T4 is at least about 50° C., at least about 100° C., at least about 150° C. and even at least about 200° C. higher than T2.

In embodiments, the devitrifying further comprises: v. subsequent to iv, holding the incipient glass-ceramic composition in an environment maintained at a temperature T5 substantially lower than T4; and vi. subsequent to v, holding the incipient glass-ceramic in an environment maintained at a temperature T6 substantially higher than T5. In embodiments T5 is substantially equal to T1, for example T5=T1±50° C. or even T5=T1±25° C. In embodiments T6 is substantially equal to T4, for example T6=T4±50° C. or even T6=T4±25° C. In embodiments, T6 is substantially higher than T4, for example, T6 is at least about 50° C., at least about 100° C., at least about 150° C. and even at least about 200° C. higher than T4.

In embodiments, the devitrifying further comprises: vii. subsequent to vi, holding the incipient glass-ceramic composition in an environment maintained at a temperature T7 substantially lower than T6; and viii, subsequent to vii, holding the incipient glass-ceramic in an environment maintained at a temperature T8 substantially higher than T7. In embodiments T7 is substantially equal to T1, for example T7=T1±50° C. or even T7=T1±25° C. In embodiments T8 is substantially equal to T6, for example T8=T6±50° C. or even T8=T6±25° C. In embodiments, T8 is substantially higher than T6, for example, T8 is at least about 50° C., at least about 100° C., at least about 150° C. and even at least about 200° C. higher than T6.

In embodiments, XO comprises at least one member of the group consisting of MgO, FeO, NiO, MnO, ZnO and mixtures thereof. In embodiments, XO constitutes at least about 4% by weight of the glass composition. In embodiments, XO constitutes no more than about 40% by weight of the glass composition.

In embodiments, Z₂O₃ comprises at least one member of the group consisting of Al₂O₃, Mn₂O₃, V₂O₃, Fe₂O₃, Cr₂O₃ and mixtures thereof. In embodiments, Z₂O₃ constitutes at least about 10% by weight of the glass composition. In embodiments, Z₂O₃ constitutes no more than about 45% by weight of the glass composition.

In embodiments, the glass composition comprises at least one nucleating agent, such as a nucleating agent selected from the group consisting of CeO₂, Cr₂O₃, F, Fe₂O₃, MnO₂, P₂O₅, SnO₂, SO₄²⁻, S²⁻, TiO₂, V₂O₅, ZnO, ZrO₂ and mixtures thereof.

In embodiments, the glass composition comprises TiO₂. In embodiments, TiO₂ constitutes at least about 1%, at least about 2%, at least about 4%, at least about 6% and even at least about 8% by weight of the glass composition. In embodiments, TiO₂ constitutes no more than about 24% by weight of the glass composition.

In embodiments, the glass composition comprises SiO₂. In embodiments, SiO₂ constitutes at least about 30% by weight of the glass composition. In embodiments, SiO₂ constitutes no more than about 70% by weight of the glass composition.

In embodiments, prior to the devitrifying, the glass composition is shaped.

According to the teachings of the present invention there is also provided a method of producing a glass-ceramic comprising: a. providing a glass composition; and b. devitrifying the glass composition by a process including i. holding the glass composition in an environment maintained at a temperature T1 to provide an incipient glass-ceramic composition; ii. subsequent to i, holding the incipient glass-ceramic in an environment maintained at a temperature T2 substantially higher than T1; subsequent to ii, holding the incipient glass-ceramic composition in an environment maintained at a temperature T3 substantially lower than T2; and iv. subsequent to iii, holding the incipient glass-ceramic in an environment maintained at a temperature T4 substantially higher than T3 thereby producing the glass-ceramic.

In embodiments, T2 is substantially higher than T1, for example, T2 is at least about 50° C., at least about 100° C., at least about 150° C. and even at least about 200° C. higher than T1.

In embodiments T3 is substantially equal to T1, for example T3=T1±50° C. or even T3=T1±25° C. In embodiments T4 is substantially equal to T2, for example T4=T2±50° C. or even T4=T2±25° C. In embodiments, T4 is substantially higher than T2, for example, T4 is at least about 50° C., at least about 100° C., at least about 150° C. and even at least about 200° C. higher than T2.

In embodiments, the devitrifying further comprises: v. subsequent to iv, holding the incipient glass-ceramic composition in an environment maintained at a temperature T5 substantially lower than T4; and vi. subsequent to v, holding the incipient glass-ceramic in an environment maintained at a temperature T6 substantially higher than T5. In embodiments T5 is substantially equal to T1, for example T5=T1±50° C. or even T5=T1±25° C. In embodiments T6 is substantially equal to T4, for example T6=T4±50° C. or even T6=T4±25° C. In embodiments, T6 is substantially higher than T4, for example, T6 is at least about 50° C., at least about 100° C., at least about 150° C. and even at least about 200° C. higher than T4.

In embodiments, the devitrifying further comprises, vii. subsequent to vi, holding the incipient glass-ceramic composition in an environment maintained at a temperature T7 substantially lower than T6; and viii. subsequent to vii, holding the incipient glass-ceramic in an environment maintained at a temperature T8 substantially higher than T7. In embodiments T7 is substantially equal to T1, for example T7=T1±50° C. or even T7=T1±25° C. In embodiments T8 is substantially equal to T6, for example T8=T6±50° C. or even T8=T6±25° C. In embodiments, T8 is substantially higher than T6, for example, T8 is at least about 50° C., at least about 100° C., at least about 150° C. and even at least about 200° C. higher than T6.

According to the teachings of the present invention there is also provided an article of manufacture including a component of a glass-ceramic of the present invention. In embodiments, the article has a shape, including but not limited to shapes such as flatware, hollowware, laboratory counter tops, artificial stones, decorative stones, chemical reaction stills, fluid transfer tubing and piping, abrasive resistant liners, table tops, tiles, roofing tiles, sidings, sinks, basins, tubs, souvenirs and curiosities.

According to the teachings of the present invention there is also provided an article for protecting an object from a kinetic threat including a component of a glass-ceramic of the present invention. In embodiments, the article comprises a textile component, e.g., of aramid or polyethylene fibers. In embodiments, the article comprises a metal component. In embodiments, the article has a shape, including but not limited to shapes such as armor plates, armor sheets, bullet-proof vests, body armor, protective inserts, panels, door panels, floor panels, wall panels, helmets, seats, roofing elements, tiles, roofing tiles, aircraft, rotary wing aircraft, fixed wing aircraft, armored fighting vehicle, limousines and motor vehicles.

According to the teachings of the present invention there is also provided a method of manufacture of an article for protecting an object from a kinetic threat comprising: a) providing a component of a glass-ceramic of the present invention; and b) associating the glass-ceramic component with at least one additional component. In embodiments the at least one additional component comprises a textile, e.g., of aramid or polyethylene fibers. In embodiments, the additional component comprises a textile and the associating includes binding the additional component to the glass-ceramic component using an adhesive. In embodiments, the additional component is a textile and the associating includes encasing the glass-ceramic component in the additional component. In embodiments, the additional component comprises a metal sheet and the associating includes binding the additional component to the glass-ceramic component using an adhesive.

According to the teachings of the present invention there is also provided a method of protecting an object from kinetic threats comprising providing the object with armor comprising a component of a glass-ceramic of the present invention.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

Embodiments of the invention are herein described, by way of example only, with reference to the accompanying drawings. With specific reference now to the drawings in detail, it is stressed that the particulars shown are by way of example and for purposes of illustrative discussion of embodiments of the present invention only, and are presented in the cause of providing what is believed to be the most useful and readily understood description of the principles and conceptual aspects of embodiments of the invention. In this regard, no attempt is made to show details of the embodiments in more detail than is necessary for a fundamental understanding of the invention, the description taken with the drawings making apparent to those skilled in the art how embodiments of the invention may be embodied in practice.

In the drawings:

FIG. 1 (prior art) is a graph showing the relationship between temperature and the nucleation center formation rate (dashed) and the crystallization rate (solid); and

FIGS. 2A-2F are graphs depicting the temperature as a function of time of devitrification regimes of the present invention.

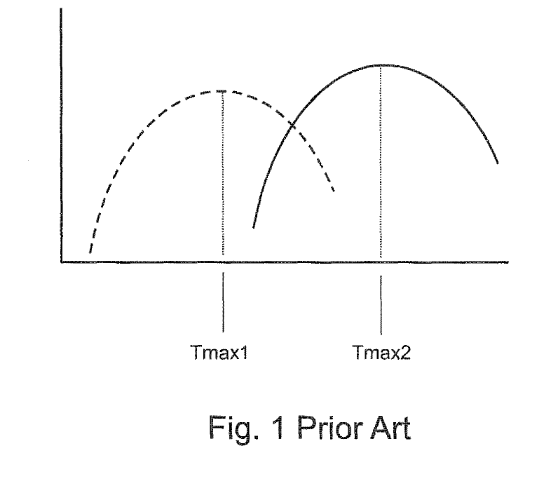

### DESCRIPTION OF EMBODIMENTS

The present invention is of glass-ceramics including Spinel group crystals as a predominant crystal phase and methods of making the same. The present invention is also of relatively hard glass-ceramics and methods of making the same. The present invention is also of articles made of such glass-ceramics. The present invention is also of methods and of articles of manufacture for protecting an object from kinetic threats. The present invention is also of methods of manufacturing articles for protecting an object from a kinetic threat.

The principles and uses of the teachings of the present invention may be better understood with reference to the accompanying description, figures and examples.

Generally, the nomenclature used herein and the laboratory procedures utilized in the present invention include techniques from the fields of chemistry, engineering, material sciences and physics. Such techniques are thoroughly explained in the literature. Unless otherwise defined, all technical and scientific terms used herein have the same meaning as commonly understood by one of ordinary skill in the art to which the invention belongs. In addition, the descriptions, materials, methods, and examples are illustrative only and not intended to be limiting. Methods and materials similar or equivalent to those described herein can be used in the practice or testing of the present invention.

As used herein, the terms “comprising” and “including” or grammatical variants thereof are to be taken as specifying the stated features, integers, steps or components but do not preclude the addition of one or more additional features, integers, steps, components or groups thereof. This term encompasses the terms “consisting of” and “consisting essentially of”.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed article, composition, device or method.

As used herein, “a” or “an” mean “at least one” or “one or more”. The use of the phrase “one or more” herein does not alter this intended meaning of “a” or “an”.

As used herein, the term “process” and the term “method” refers to manners, means, techniques and procedures for accomplishing a given task including, but not limited to, those manners, means, techniques and procedures either known to, or readily developed from known manners, means, techniques and procedures by practitioners of the chemical, material, defense, ceramic and other applicable arts. Implementation of the methods of the present invention involves performing or completing selected tasks or steps manually, automatically, or a combination thereof.

Before explaining at least one embodiment of the present invention in detail, it is to be understood that the present invention is not limited in its application to the details set forth in the following description or as exemplified by the Examples. It is to be understood that the phraseology and terminology employed herein is for the purpose of description and should not be regarded as limiting.

In an aspect of the present invention, glass-ceramics comprising Spinel-group crystals as the predominant crystal phase or phases are provided. Unlike prior art glass-ceramics that have reported the incidental formation of Spinel-group crystals, in embodiments of the present invention the crystal phase or phases of glass-ceramics of the present invention are predominantly Spinel-group crystals, that is to say that Spinel-group crystal phase or phases are the most abundant of the crystal phases of the glass-ceramic. One commonly used method of determining the dominant crystal phase in a glass-ceramic is with quantitative X-ray diffraction. In an aspect of the present invention, glass-ceramics having relatively high bulk hardness are provided.

In embodiments, the production of glass-ceramics of the present invention is relatively cheap and simple, involving devitrification of relatively cheap glass compositions at relatively low temperatures.

It has been found that embodiments of glass-ceramics of the present invention are extremely hard, including bulk glass-ceramics (i.e., as opposed to glass-ceramic thin films and coatings, monolithic objects having dimensions greater than about 1 mm, greater than about 2 mm or even greater than about 3 mm in three dimensions) having a hardness of at least about 11, at least about 12, at least about 13, at least about 14, at least about 15 and even at least about 16 GPa (Vickers). In the art, the hardest bulk glass-ceramics reported have a Vicker's hardness of 10.3 GPa (see U.S. Pat. No. 4,755,488), 10.8 GPa (see U.S. Pat. No. 5,060,553) and 10 GPa (see WO2005/119163 and US 2005/0119104 both of the inventor). Since an objective of embodiments of the present invention is to provide glass-ceramics useful in protecting sensitive objects from kinetic threats, it is important to provide glass-ceramics that are hard.

Further, it has been found that articles incorporating components made of embodiments of glass-ceramics of the present invention are exceptionally effective in protecting sensitive objects from kinetic threats and therefore are suitable for use in armors and the like.

Further, it has been found that some embodiments of glass-ceramics of the present invention are both sufficiently cheap and sufficiently durable to be useful in the manufacture of consumer goods and construction materials that are typical made of stone, ceramics, glazed ceramics and the like such as flatware (e.g., plates), hollowware (e.g., bowls, cups, jugs, pitchers), table tops, tiles, roofing tiles, sidings, sinks, basins, tubs, souvenirs and curiosities.

Spinel-group crystals are double oxides having the general formula XO—Z₂O₃ where X is a divalent metal ion such as one or more of Mg²⁺, Fe²⁺, Ni²⁺, Mn²⁺, Zn²⁺ and mixtures thereof and Z is a trivalent metal ion such as one or more of Al³⁺, Fe³⁺, V³⁺, Cr³⁺, Mn³⁺ and mixtures thereof.

Representative Spinel-group crystals include valid mineral species that are homogenous types (that is having an X of a single type and a Z of a single type) such as Spinel (MgO—Al₂O₃), Gahnite (ZnO—Al₂O₃), Hercinyte (FeO—Al₂O₃), Magnetite (FeO—Fe₂O₃) and Chromite (FeO—Cr₂O₃) as well as heterogeneous types such as Galaxite ((Mn,Fe,Mg)O—(Al,Fe)₂O₃), Galaxite ((Mn,Mg)O—Al₂O₃), Galaxite (MgO—(Al,Fe)₂O₃), Galaxite (MnO—Al₂O₃), Franklinite ((Zn,Fe)O—Mn₂O₃) and Magnesiochromite ((Mg,Fe)O—(Al,Cr)₂O₃). Spinel-group crystals include not valid mineral species such as members of the Gahnite-Spinel series ((Zn, Mg)OAl₂O₃), the Magnesiochromite-Spinel Series (Mg,Fe)O(Al,Cr)₂O₃—MgOAl₂O₃), the Chromite-Hercynite Series (FeOCr₂O₃—FeOAl₂O₃), the Chromite-Magnesiochromite Series (FeOCr₂O₃—(Mg,Fe)O(Al,Cr)₂O₃). the Gahnite-Hercynite Series (ZnOAl₂O₃—FeOAl₂O₃) and the Hercinyte-Spinel series ((Fe,Mg)O—Al₂O₃).

It has been found that some embodiments of glass-ceramics of the present invention where Z is Al³⁺ have advantageous material properties that contribute to the usefulness of the glass-ceramics in armor and non-armor applications.

An object of embodiments of the present invention is to provide cheap glass-ceramics. As a result, embodiments of glass-ceramics of the present invention are prepared using impure, thus cheap, raw materials. Due to the use of impure raw materials, the Spinel-group crystal phases of such embodiments of glass-ceramics of the present invention are generally not homogeneous crystals but rather included heterogeneous crystals including different Xs and Zs. Specifically, embodiments of glass-ceramics of the present invention having a predominant substantially homogenous Spinel (MgO—Al₂O₃) crystal phase prepared from a glass composition including relatively significant amounts of Fe₂O₃ and Cr₂O₃ (and thus can also be considered as belonging to the Magnesiochromite-Spinel series (MgO—(Al, Fe, Cr)₂O₃) or Galaxite (MgO—(Al, Fe)₂O₃)) were found to have a Vickers hardness of between 10.0 and 11.7. Embodiments of glass-ceramics of the present invention having a predominant substantially homogenous Spinel (MgO—Al₂O₃) crystal phase prepared from a glass composition including relatively small amounts of Fe₂O₃ (and thus can also be considered as a sort of heterogeneous Galaxite (MgO—(Al,Fe)₂O₃)) were found to have a Vickers hardness of between 13.2 and 13.6. Embodiments of glass-ceramics of the present invention having a predominant substantially homogenous Spinel (MgO—Al₂O₃) crystal phase prepared from a glass composition including relatively small amounts of MnO (and thus can also be considered as a sort heterogeneous Galaxite ((Mn,Mg)O—Al₂O₃)) were found to have a Vickers hardness of between 14.2 and 16.6. Embodiments of glass-ceramics of the present invention prepared from a glass composition including a 1:1 molar ratio of ZnO to MgO having a heterogeneous Spinel-group crystal phase belonging to the Gahnite-Spinel series ((Zn,Mg)O—Al₂O₃) crystal phase were found to have a Vickers hardness of between 12.4 and 15.3 GPa. Embodiments of glass-ceramics of the present invention prepared from a glass composition including a 1.14:1 molar ratio of MnO to MgO having a predominant heterogeneous Galaxite ((Mn,Mg)O—Al₂O₃) crystal phase were found to have a Vickers hardness of between 12.9 and 13.1 GPa.

Important for the material properties of a glass-ceramic is the nature of the glass-phase that remains after formation of the crystal phase or phases and in which the crystals are suspended. It has been found that some embodiments of glass-ceramics of the present invention with a glass phase comprising SiO₂ have advantageous material properties. Embodiments of the glass-ceramics of the present invention are configured so that the glass-phase comprises SiO₂ or comprises predominantly SiO₂.

Important for the material properties of a glass-ceramic is the nature of the nucleating agent. It has been found that some embodiments of the glass-ceramics of the present invention with TiO₂ as a nucleating agent have advantageous material properties. Glass compositions used to produce embodiments of glass-ceramics of the present invention include TiO₂ as a nucleating agent. Further, it has been found that some embodiments of glass-ceramics of the present invention having a TiO₂ crystal phase in addition to a Spinel-group crystal phase or phases have advantageous material properties. Embodiments of glass-ceramics of the present invention include a TiO₂ crystal phase, e.g., Rutile, in addition to a Spinel-group crystal phase or phases.

### Production of Glass-Ceramics of the Present Invention

The production of a glass-ceramic requires the preparation of a glass composition followed by devitrification of the glass composition to produce the glass-ceramic. In the art it is known to combine different ores, sands and inorganic mixtures from various sources in proportions so that the resulting combined glass composition has proportions of individual mineral components that resemble, to some extent, the stochiometry of a desired crystal phase (see WO2005/119163 and US 2005/0119104 both of the inventor). The actual formation of the desired crystal phase from such a mixture during devitrification is not necessarily straightforward as the crystallization process is dependent on other components of the glass composition (including the nature of the nucleating agent and the non-crystallizing components of the glass composition) and the devitrification regime used. Further, even if the desired crystal phase or phases is produced, the physical properties of the resulting glass-ceramic are also dependent on such factors as the presence of other crystal phases, the size of the crystals and the nature of the glass phase, which are dependent on the glass composition from which the glass-ceramic was made and on the devitrification regime used.

### Glass Compositions

As noted above, embodiments of glass-ceramics of the present invention include a predominant Spinel-group crystal phase of the stochiometry XO—Z₂O₃.

In order to allow Spinel-group crystals to form in a glass-ceramic, it is necessary that a glass composition used for preparing the glass-ceramic include a significant proportion of a divalent metal oxide XO. Typical divalent metal oxides that are constituents of Spinel-group crystals and that are useful as components of a glass composition for the preparation of a glass-ceramic of the present invention include but are not limited to MgO, FeO, NiO, MnO, ZnO and mixtures thereof. In embodiments, substantially only a single divalent metal oxide is present in such a glass composition, that is to say there is one predominant divalent metal oxide pure or accompanied by minor amounts of one or more additional divalent metal oxides. In embodiments, a combination of two or more different divalent metal oxides in significant amounts is present in such a glass composition. In embodiments, a glass-composition includes at least about 4%, at least about 5%, at least about 6%, at least about 7% and even at least about 9% by weight of divalent metal oxides XO. As seen in the examples below, embodiments of glass-compositions include up to about 40% by weight of divalent metal oxide.

In order to allow Spinel-group crystals to form in a glass-ceramic, it is necessary that a glass composition used for preparing the glass-ceramic include a significant proportion of a trivalent metal oxide Z₂O₃. Typical trivalent metal oxides that are constituents of Spinel-group crystals and that are useful as components of a glass-composition for the preparation of a glass-ceramic of the present invention include but are not limited to Al₂O₃, Mn₂O₃, V₂O₃, Fe₂O₃, Cr₂O₃ and mixtures thereof. In embodiments, substantially only a single trivalent metal oxide is present in such a glass composition, that is to say there is one predominant trivalent metal oxide pure or accompanied by minor amounts of one or more additional trivalent metal oxides. In embodiments, a combination of two or more different trivalent metal oxides in significant amounts is present in such a glass composition. It has been found that some glass compositions including Al₂O₃ (that allow formation of Spinel, Galaxite, Gahnite and Hercynite crystal phases) provide hard glass-ceramics suitable for use, for example, in protecting against kinetic threats. In embodiments, Al₂O₃ constitutes at least about 50%, at least about 66%, at least about 75%, at least about 85% and even at least about 95% by weight of total Z₂O₃. In embodiments, a glass-composition includes at least 10%, at least 12%, at least 14% and even at least 16% by weight of a trivalent metal oxide Z₂O₃. As seen in the examples below, embodiments of glass-compositions include up to about 45% by weight of trivalent metal oxides.

In order to allow Spinel-group crystals to form in a glass-ceramic, it is necessary that a glass composition used for preparing the glass-ceramic have some resemblance to the stoichiometric proportions of divalent metal oxides XO to trivalent metal oxides Z₂O₃ of a desired crystal phase. That said, not every glass composition having a nearly exact stochiometry of the desired crystal phase is suitable for producing the desired glass-ceramic: it is preferred that there be a substantially homogenous molten glass phase that initially includes the components of the crystal phase or phases and these must effectively crystallize out without having a physical phase separation. Further, it is preferred that crystallization occur during a defined crystallization step allowing formation of numerous individual small crystals, and not in an earlier step of the production process such as in a vitrification oven where the raw materials are combined, melted and cooked to provide the molten glass composition, or during a shaping, molding or annealing step. In embodiments, there is a molar excess of the divalent metal oxide XO relative to the stochiometry of the desired crystal phase in a glass composition. In embodiments, there is a molar excess of the trivalent metal oxide Z₂O₃ in a glass composition. In embodiments, the ratio of XO to Z₂O₃ is at least about 1:0.2, at least about 1:0.25 and even at least about 1:0.4. In embodiments, the ratio of XO to Z₂O₃ is no more than about 1:3, no more than about 1:2.5 and even no more than about 1:2.

### Nucleating Agents

As noted above, when producing a glass-ceramic, it is important to select a suitable nucleating agent. Many nucleating agents suitable for implementing the teachings of the present invention are known, including but not limited to CeO₂, Cr₂O₃ (provided, for example, as Cr₂O₃, K₂CrO₄ or K₂Cr₂O₇), F⁻ (provided, for example, as Na₃AlF₆, Na₂SiF₆ or CaF₂), Fe₂O₃, MnO₂, P₂O₅ (provided, for example, as (NH₄)₂HPO₄, Ca₃(PO₄)₂ or Ca(H₂PO₄)₂), SnO₂ (provided, for example, as Cassiterite, Sn₂O₄), SO₄²⁻, S²⁻, TiO₂ (provided, for example, as Rutile, Ilmenite FeTiO₃ or Ilmenite where a significant proportion of the FeO has been isomorphically exchanged with MgO (up to 17%) or MnO (up to 14%)), V₂O₅, ZnO, ZrO₂ (provided, for example, as Zircon ZrSiO₄) and mixtures thereof.

TiO₂ is a known nucleating agent added to glass compositions for producing glass-ceramics. Rutile sand, a readily available mineral source of Rutile (a-TiO₂), added as a component of a glass composition has been found to provide satisfactory results for the production of glass-ceramics of the present invention.

It has been found that embodiments of glass-ceramics of the present invention prepared from glass compositions including TiO₂ have advantageous material properties. When a glass composition of the present invention formulated for the preparation of a glass-ceramic of the present invention includes TiO₂ as a nucleating agent, preferably the glass composition (and the resulting glass-ceramic) includes at least about 1% by weight TiO₂, at least about 2% by weight TiO₂, at least about 4%, at least about 5%, at least about 6% and even at least about 8% by weight TiO₂. Embodiments generally include up to about 24% by weight TiO₂. Typically, embodiments include between about 6% and about 20% by weight TiO₂.

### Non-Crystallizing Portion

As noted above, the properties of a glass-ceramic are in part dependent on the components of the glass composition that do not crystallize during devitrification and make up the glass phase of the produced glass-ceramic. The influence of the non-crystallizing components is important both during the devitrification process and once the glass-ceramic is formed.

In general any suitable glass phase may be used for implementing the teachings of the present invention. SiO₂ is readily available at low prices in both coal ash and silica sand, and when added as a constituent component of a glass composition has been found to provide satisfactory results for the production of embodiments of glass-ceramics of the present invention where subsequent to vitrification the glass phase includes, even predominantly includes, amorphous SiO₂. In embodiments, a glass composition (and consequently the glass-ceramic produced there form) includes at least about 30% and even at least about 35% by weight SiO₂. In embodiments, a glass composition includes not more than about 70% and even not more than about 65% by weight SiO₂.

Glass compositions suitable for the preparation of embodiments of glass-ceramics of the present invention are listed in Tables 1 and 2.

TABLE 1
Glass compositions suitable for preparing glass-ceramics of the present
invention (molar ratio)

| | Z₂O₃ | | | | | | | | |
|---|---|---|---|---|---|---|---|---|---|
| | 0.2 | 0.25 | 0.4 | 0.6 | 1 | 1.5 | 2 | 2.5 | 3 |
| XO | 1 | 1 | 1 | 1 | 1 | 1 | 1 | 1 | 1 |

TABLE 2
Glass compositions suitable for preparing glass-ceramics of the present
invention (weight percent of the composition, dash means optionally present in a
non-specified amount)

| | 1 | 2 | 3 | 4 | 5 | 6 | 7 | 8 | 9 |
|---|---|---|---|---|---|---|---|---|---|
| SiO₂ | — | — | — | — | — | — | 30-70 | 30-70 | 35-65 |
| Z₂O₃ | 10-45 | 12-45 | 14-45 | 16-45 | 10-45 | 10-45 | 10-45 | 10-45 | 10-30 |
| XO | 4-40 | 5-40 | 6-40 | 7-40 | 4-40 | 4-40 | 4-40 | 4-40 | 4-30 |
| Nucleating | — | — | — | — | 1-25 | 1-20 | 1-25 | 6-20 | 6-20 |
| agent | | | | | | | | | |

| | 10 | 11 | 12 | 13 | 14 | 15 | 16 | 17 | 18 | 19 |
|---|---|---|---|---|---|---|---|---|---|---|
| SiO₂ | 38-62 | 42-56 | 38-54 | 38-52 | 40-55 | 30-70 | 30-70 | 30-70 | 30-70 | 30-70 |
| Al₂O₃ | 14-32 | 22-29 | 20-34 | 14-24 | 16-25 | 0-45 | 10-45 | 10-45 | 10-45 | 10-45 |
| Fe₂O₃ | 2.5-10 | 0-1 | — | — | — | 0-20 | — | — | — | — |
| Cr₂O₃ | 0-3 | — | — | — | — | 0-15 | — | — | — | — |
| MgO | 6-24 | 6-24 | 5-25 | 6-24 | 5-12 | 0-30 | 4-30 | — | — | — |
| MnO | — | — | 0-6 | — | 16-22 | 0-30 | — | 4-30 | — | — |
| ZnO | — | — | — | 10-22 | — | 0-30 | — | — | 4-30 | — |
| FeO | — | — | — | — | — | 0-20 | — | — | — | 4-20 |
| TiO₂ | 1-24 | 6-18 | 7-20 | 6-18 | 8-20 | 0-20 | 0-20 | 0-20 | 0-20 | 0-20 |
| CaO | 1-8 | 0-1 | — | — | — | — | — | — | — | — |
| K₂O | 0-2.5 | 0-2 | — | — | — | — | — | — | — | — |
| Na₂O | 0-0.6 | 0-1 | — | — | — | — | — | — | — | — |
| SO₃ | 0-2.8 | — | — | — | — | — | — | — | — | — |
| P₂O₅ | 0-6 | — | — | — | — | — | — | — | — | — |
| ZrO₂ | — | 0-1 | 0-7 | — | — | — | — | — | — | — |
| CeO₂ | — | — | 0-8 | — | — | — | — | — | — | — |
| MnO₂ | — | — | 0-6 | — | 0-6 | — | — | — | — | — |

| | 20 | 21 | 22 | 23 | 24 | 25 |
|---|---|---|---|---|---|---|
| SiO₂ | 35-48 | 39-45 | 41-47 | 42-46 | 41-47 | 42-44 |
| Al₂O₃ | 12-34 | 15-29 | 15-21 | 17-19 | 16-20 | 17-19 |
| Fe₂O₃ | 0.1-7 | 0.1-5 | | | | |
| Cr₂O₃ | | | | | | |
| MgO | 9-17 | 12-15 | 6-12 | 8-10 | 8-11 | 9-10 |
| MnO | 0-3 | 1-2 | | | 16-22 | 17-21 |
| ZnO | | | 15-21 | 17-19 | | |
| FeO | | | | | | |
| TiO₂ | 10-18 | 11-16 | 9-13 | 10-12 | 9-15 | 11-13 |
| CaO | | | | | | |
| K₂O | | | | | | |
| Na₂O | | | | | | |
| SO₃ | | | | | | |
| P₂O₅ | | | | | | |
| ZrO₂ | 0-3.5 | 0-3.5 | | | | |
| CeO₂ | 0-2 | 0-2 | | | | |
| MnO₂ | 0-2.5 | 0-2.5 | | | 0-6 | 0-4 |

### Raw Materials

As noted above, in the art it is known to use impure raw materials in the preparation of glass-ceramics. Thus, in embodiments of the present invention impure raw materials such as ores, sands and inorganic mixtures from various sources are combined in proportions so that the resulting composition includes a sufficient amount of a desired nucleating agent, a sufficient amount of material that is to be the glass phase and a sufficient amount of other materials such as oxides XO and Z₂O₃ in proportions that allow formation of the desired crystal phase or phases. The impurities in the raw materials constituting the glass composition that are not components of the desired crystal phases either incidentally crystallize to form secondary crystal phases or remain as components of the glass phase of the produced glass-ceramic. That said, it has been found that in some cases, glass-ceramics of the present invention produced from higher purity raw materials are harder and have more homogenous crystal phases.

Precursor materials known in the art and which are useful as constituent components of a glass composition used for preparing embodiments of glass-ceramics of the present invention include waste materials and industrial grade materials having a relatively high content of one or more desired components. Such materials include industrial grades of alumina, aluminum dross, asbestos, auto shredder residue, batteries, blast furnace slag, cement waste, coal mine schist, coal fly ash, coal bottom ash, concrete, contaminated soils, cullet, demolition waste, dolomite, electric arc furnace dust, electroplating waste, flue gas desulfurization waste, geological mine tailings, incinerator ash, inorganic filter media, ion-exchange resins, municipal waste incinerator residue, paint waste, paper ash, photographic waste, industrial grades of sands, sewage sludge ash, scrap metal waste, industrial grades of silica, sludge solids, solid residue of aqueous waste streams, spent filter aids, steel slag, tile dust, titania, urban waste, zeolites, zinc slag, and mixtures thereof.

Due to its availability, low cost and composition, a suitable precursor material for formulating a glass composition in accordance with the teachings of the present invention is coal ash, especially coal fly ash that generally contains significant amounts of SiO₂, Al₂O₃ and other minerals. In embodiments of the present invention, a glass composition used in the production of a glass-ceramic includes coal ash, especially coal fly ash, as a constituent.

An additional suitable precursor material for formulating a glass composition in accordance with the teachings of the present invention is waste ash. Many waste disposal organizations gather and incinerate various types of waste. The resulting ash is readily available and often contains minerals in proportions that are useful in implementing the teachings of the present invention. In embodiments of the present invention, a glass composition used in the production of a glass-ceramic includes waste ash as a constituent.

In embodiments of the present invention an amount of coal ash or waste ash is provided and the mineral content thereof analyzed. Depending on the glass composition desired, suitable amounts of additional precursor materials are combined with the coal ash and/or waste ash so that the weight ratio of the various components of the resulting glass composition somewhat resemble the ratios desired for the formation of the desired crystal phase or phases.

A suitable SiO₂-containing precursor material useful as a constituent component of embodiments of a glass composition in accordance with the teachings of the present invention is silica sand or quartz.

A suitable TiO₂-containing precursor material useful as a constituent component of embodiments of a glass composition in accordance with the teachings of the present invention is Rutile sand.

Suitable precursor materials useful as constituent components of embodiments of glass compositions in accordance with the teachings of the present invention, such as MgO, MgCO₃, Mg(OH)₂, FeO, MnO or ZnO include standard materials of various industrial grades.

### Production of a Glass-Ceramic of the Present Invention

In general, production of a glass-ceramic of the present invention includes at least two substantial steps: preparing an appropriate glass composition and devitrifying the glass composition to produce a glass-ceramic of the present invention.

### Vitrification

In embodiments, a glass composition in accordance with the teachings of the present invention is prepared from precursor materials using conventional glass melting and forming equipment. For example, the precursor materials are melted in a tank or crucible to provide a, preferably homogenous, molten glass composition. In embodiments, melting of glass compositions as described above is performed in an electrical furnace at a temperature of between about 1450° C. and 1550° C.

### Devitrification

As noted above, for production of a glass-ceramic, components of a glass composition are allowed to crystallize, forming one or more crystal phases suspended in a glass phase.

In embodiments, a molten glass composition as described above is devitrified. In embodiments a molten glass composition is allowed to solidify by cooling, e.g. to room temperature and subsequently devitrified. In embodiments, a molten glass composition is allowed to solidify, annealed and subsequently devitrified.

In embodiments, a molten glass composition as described above is shaped (e.g., molded, cast) and is subsequently devitrified (vide infra) without cooling to room temperature. In embodiments, the molten glass composition is cast in an appropriately shaped mold, preferably a press mold. In embodiments, the molten glass is pressed into the appropriate shape, removed from the mold and then introduced into a kiln for devitrification. In embodiments devitrification is performed in the mold, especially press molding.

In embodiments, a molten glass composition is allowed to solidify and the mechanically shaped with or without annealing, whether prior or subsequent to the mechanical shaping. In embodiments, a molten glass composition is hot-formed in a molten state, for example by draping or vacuum drawing to produce a desired shape before cooling. The resulting shaped glass composition is devitrified after cooling (e.g., to room temperature) and, optionally, storage. In embodiments the glass composition is simply cooled. In embodiments, the glass composition is annealed (in embodiments, at a temperature of between about 675° C. and 750° C. for a period of up to 3 hours and then cooled to room temperature, in embodiments at a rate of between −30 and −120° C./hour, preferably at a rate of −60° C./hour).

As is known in the art, the devitrification regime is of importance in determining the properties of a resulting glass-ceramic: even if an appropriate glass composition is provided, it is generally difficult to prepare a glass-ceramic with desired properties if an inappropriate devitrification regime is used. During devitrification, a glass composition is maintained at an elevated temperature (generally lower than the melting temperature) during which time components of the composition crystallize to form one or more crystal phases so as to produce a glass-ceramic. As noted in the introduction, in the art different devitrification regimes are known including a one-stage devitrification regime where devitrification is performed at a constant temperature and a two-stage devitrification regime where a high rate of nucleation center production is occurs at a first temperature and a high crystal growth rate occurs at a second temperature higher than the first. The steps, the temperature, the duration and rate of change of temperature between any two-steps determine characteristics such as the type of crystal phases formed and the size of the individual crystals.

The importance of an appropriate devitrification regime when practicing the teachings of the present invention is understood when considering that Cordierite (2MgO:2Al₂O₃:5SiO₂) is the equilibrium crystal phase of glass compositions useful in implementing the teachings of the present invention. Cordierite formation proceeds through a complex chain of metastable crystal phases including quartz, cristobalite, mullite, magnesium alumo-titanates, Spinel (MgO:Al₂O₃), Sapphirine (4MgO:5Al₂O₃:SiO₂) and finally Cordierite. The phase transformations are continuous without precisely defined borders between different crystal phases. Thus, a suitable devitrification regime must be found to ensure a primacy of desired Spinel-group crystal phases with as little as possible undesirable crystal phases.

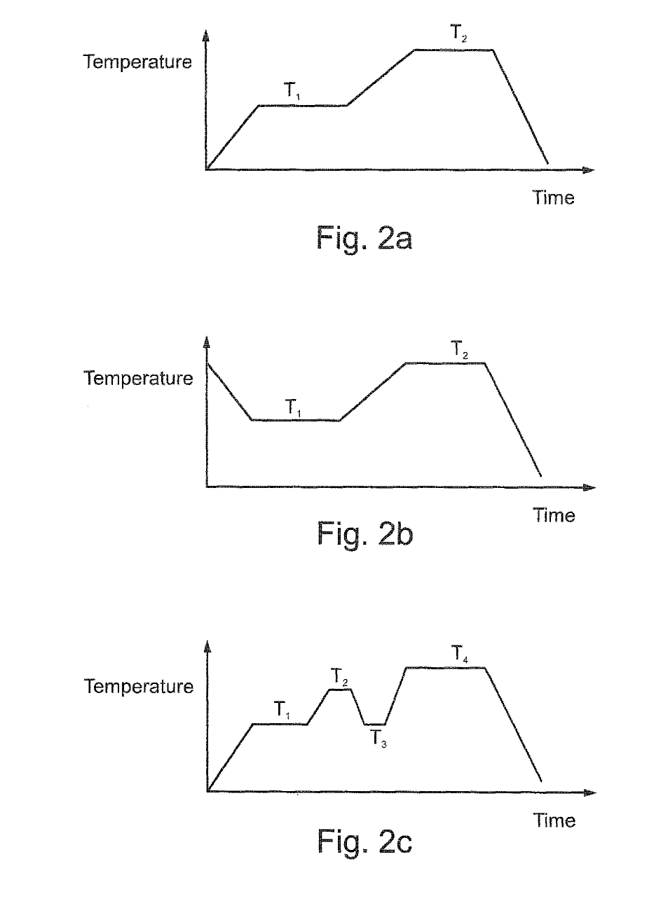

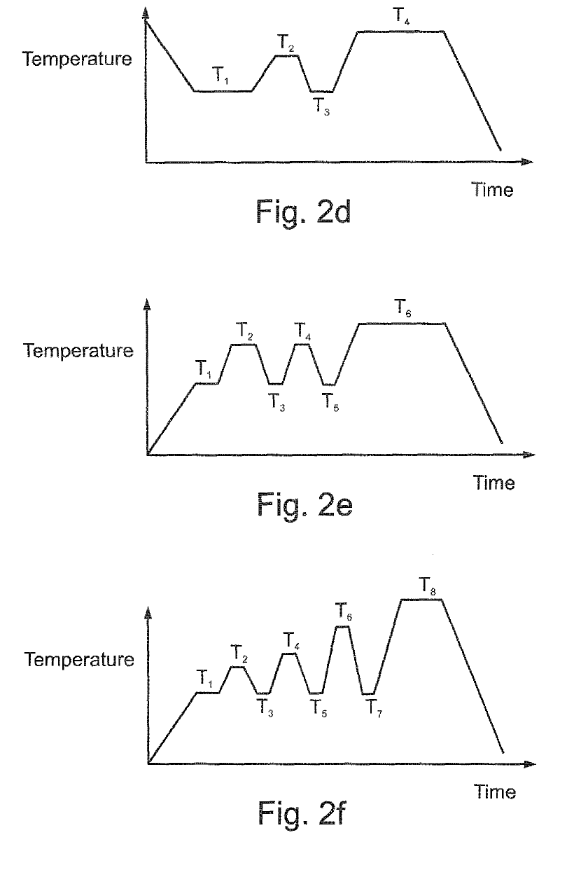

Six different devitrification regimes that have been found useful in implementing the teachings of the present invention to produce glass-ceramics of the present invention including a primary Spinel-group crystal phase are schematically depicted in FIGS. 2A-2F. It is seen that regimes A and B depicted in FIGS. 2A and 2B are substantially similar, the difference being that in Regime A the glass composition begins as a cool annealed glass composition whereas in Regime B the glass composition begins as a hot molten glass. Similarly, it is seen that Regimes C and D depicted in FIGS. 2C and 2D are substantially similar, the difference being that in Regime C the glass composition begins as a cool annealed glass composition whereas in Regime D the glass composition begins as a hot molten glass composition.

Generally, a glass composition is maintained at a first temperature T1, generally for a period of time, generally between about 30 minutes and about 48 hours. Subsequently, the composition is heated (typically at a rate of 30-360° C./h) to a temperature T2 higher than T1 but not more than a temperature where the composition completely melts and is maintained at T2 for a period of time, generally between about 30 minutes and about 48 hours.

According to Regimes A and B devitrification ends and the composition, now a glass-ceramic of the present invention, is cooled substantially to room temperature, typically at a rate of 30-360° C./h or otherwise finished. According to Regimes, C, D, E, F and others, the composition is cooled to a temperature T3 and is maintained at temperature T3 for a period of time, generally for longer than about 30 minutes but for not more than about 48 hours. Temperature T3 is preferably substantially equal to T1 or approximately T1 (±50° C. or even ±25° C.). Subsequently, the composition is heated, preferably at a rate of 30-360° C./h, to a temperature T4 substantially equal to or higher than T2 but not more than a temperature where the composition completely melts and is maintained at T4 for a period of time, generally for longer than about 30 minutes but for not more than about 48 hours.

According to Regimes C and D devitrification ends and the composition, now a glass-ceramic of the present invention, is cooled substantially to room temperature, typically at a rate of 30-360° C./h or otherwise finished. According to Regimes E, F and others, the glass mixture is cooled to a temperature T5 and is maintained at temperature T5 for a period of time, generally for longer than about 30 minutes but for not more than about 48 hours. Temperature T5 is preferably substantially equal to T1 or approximately T1 (±50° C. or even ±25° C.). Subsequently, the composition is heated, preferably at a rate of 30-360° C./h, to a temperature T6 substantially equal to or higher than T4 but not more than a temperature where the composition completely melts and is maintained at T4 for a period of time, generally for longer than about 30 minutes but for not more than about 48 hours.

According to Regime E devitrification ends and the composition, now a glass-ceramic of the present invention, is cooled substantially to room temperature, typically at a rate of 30-360° C./h or otherwise finished. According to Regimes F and others, the composition is subsequently cooled to a temperature T7 and is maintained at temperature T7 for a period of time, generally for longer than about 30 minutes but for not more than about 48 hours. Temperature T7 is preferably substantially equal to T1 or approximately T1 (±50° C. or even ±25° C.). Subsequently, the composition is heated, preferably at a rate of 30-360/h, to a temperature T8 substantially equal to or higher than T6 but not more than a temperature where the composition completely melts and is maintained at T8 for a period of time, generally for longer than about 30 minutes but for not more than about 48 hours.

According to Regime F devitrification ends and the composition, now a glass-ceramic of the present invention, is cooled substantially to room temperature, typically at a rate of 30-360° C./h or otherwise finished. According to other regimes the cycle of cooling to a temperature substantially equal to or approximately T1 and then reheating the composition to a temperature that is substantially equal to or higher than the preceding highest temperature but not more than a temperature where the composition completely melts is repeated one or more times.

Typical values for temperatures T1-T8 for devitrification of the above described glass compositions to yield glass-ceramics of the present invention are presented in Table 4.

TABLE 4
Temperature ranges in ° C. for devitrification of glass
compositions yielding glass-ceramics of the present invention

| | Regimes | Regimes | | |
|---|---|---|---|---|
| | A and B | C and D | Regime E | Regime F |
| T1 | 650-900 | 650-900 | 650-900 | 650-900 |
| T2 | 950-1320 | 950-1150 | 950-1150 | 950-1050 |
| T3 | | 700-900 | 700-900 | 700-900 |
| T4 | | 1000-1350 | 950-1150 | 1050-1150 |
| T5 | | | 700-900 | 700-900 |
| T6 | | | 950-1150 | 1150-1250 |
| T7 | | | | 700-900 |
| T8 | | | | 1250-1350 |

### Glass-Ceramics

A glass-ceramic resulting from devitrification of glass compositions as described above has the same elemental composition as the glass composition but comprises one or more crystal phases suspended in a glass phase.

### Specific Embodiments

Three specific embodiments of glass-ceramics of the present invention are a glass-ceramic including a Spinel (MgO—Al₂O₃) crystal phase, a glass-ceramic including a Gahnite-Spinel series ((Zn,Mg)O—Al₂O₃) crystal phase and a glass-ceramic including a Galaxite ((Mn,Mg)O—Al₂O₃) crystal phase.

Glass-Ceramic with a Spinel (MgO—Al₂O₃) Crystal Phase

Spinel (MgO—Al₂O₃) is 28% MgO and 72% Al₂O₃ by weight (a weight ratio of 1 MgO:2.5Al₂O₃. Some embodiments of glass-ceramics of the present invention with a primary Spinel crystal phase are produced by devitrification of glass compositions including at least 4%, at least 5%, at least 6% and even at least 9% by weight MgO and at least 10%, at least 14% or even at least 16% by weight Al₂O₃. Considering that in Spinel the weight ratio of MgO to Al₂O₃ is 1:2.5, some embodiments of glass-ceramics of the present invention with a predominant Spinel crystal phase are produced from glass having an MgO to Al₂O₃ weight ratio of between about 1:0.5 and about 1:7.5, between about 1:1.5 and about 1:5 or even between about 1:2 and 1:3.

Such glass compositions generally include a nucleating agent, in embodiments TiO₂, in embodiments between 1 and 24% by weight. In embodiments, during devitrification the nucleating agent crystallizes to form a secondary crystal phase in the produced glass-ceramic.

In embodiments a glass composition includes SiO₂. As noted above, SiO₂ is a readily available and cheap material that is a suitable component of a glass composition useful for producing glass-ceramics of the present invention and preferably remains an important component of the glass phase of the produced glass-ceramic.

Embodiments of glass compositions generally include other components that make up a secondary crystal phase or are components of the glass phase of the produced glass-ceramic.

Exemplary glass compositions suitable for production of glass-ceramics of the present invention having a predominant Spinel crystal phase include embodiments of compositions 16, 20 and 21 in Table 2.

As detailed in the experimental section below, glass-ceramics with a predominant Spinel crystal phase and a secondary Rutile crystal phase were produced and tested for use as armor components.

A glass-composition based on coal fly ash together with MgO and Rutile sand was prepared and 20×20×1 cm glass-ceramic plates produced therefrom using the devitrification regimes described above. Glass-ceramics having a predominant Spinel crystal phase (a substantially homogeneous crystal phase including amounts of Fe₂O₃ and Cr₂O₃ in the crystals) and a secondary Rutile crystal phase produced by devitrification according to regimes A and B were found to have a hardness of between 10.0 and 11.7 GPa (10.9±8%) while such glass-ceramics produced by devitrification according to regimes B, C, D and F were found to have a hardness of between 11.1 and 13.2 GPa (12.2±9%).

A glass-composition based on industrial waste ash together with MgO and Rutile sand was prepared and 20×20×1 cm glass-ceramic plates produced therefrom using the devitrification regimes described above. Glass-ceramics having a predominant Spinel crystal phase (a substantially homogeneous crystal phase including amounts of Fe₂O₃ in the crystals) and a secondary Rutile crystal phase produced by devitrification according to regimes A, B, C, D, E and F were found to have a hardness of between 13.2 and 13.6 GPa (13.4±2%).

A glass composition based on industrial grade raw materials was prepared and 20×20×1 cm glass-ceramic plates produced therefrom using the devitrification regimes described above. Glass-ceramics having a predominant Spinel crystal phase (a substantially homogeneous crystal phase including minor amounts of MnO in the crystals) and a secondary Rutile crystal phase produced by devitrification according to regimes A, B, C, D, E and F were found to have a hardness of between 14.2 and 16.6 GPa (13.8±8%).

Glass-Ceramic with a Gahnite (ZnO—Al₂O₃) Crystal Phase

Gahnite (ZnO—Al₂O₃) is 44% ZnO and 56% Al₂O₃ by weight (a weight ratio of 1 ZnO:1.25 Al₂O₃. Embodiments of glass-ceramics of the present invention with a predominant Gahnite crystal phase are produced by devitrification of glass compositions including at least 4%, at least 5%, at least 6% and even at least 9% by weight ZnO and at least 10%, at least 14% or even at least 16% by weight Al₂O₃. Considering that in Gahnite the weight ratio of ZnO to Al₂O₃ is 1:1.25, some embodiments of glass-ceramics of the present invention with a predominant Gahnite crystal phase are produced from glass having a ZnO to Al₂O₃ weight ratio of between about 1:0.25 and about 1:3.75, or between about 1:0.75 and about 1:2.5 or even between about 1:1 and 1:1.5.

Such glass compositions generally include a nucleating agent, in embodiments TiO₂, in embodiments between 1 and 24% by weight. In embodiments, during devitrification the nucleating agent crystallizes to form a secondary crystal phase in the produced glass-ceramic.

In embodiments a glass composition includes SiO₂. As noted above, SiO₂ is a readily available and cheap material that is a suitable component of a glass composition useful for producing glass-ceramics of the present invention and preferably remains an important component of the glass phase of the produced glass-ceramic.

Embodiments of glass compositions generally include other components that make up a secondary crystal phase or are components of the glass phase of the produced glass-ceramic.

Exemplary glass compositions suitable for production of glass-ceramics of the present invention having a predominant Gahnite crystal phase include embodiments of composition 18 in Table 2. Exemplary glass compositions suitable for production of glass-ceramics of the present invention having a predominant Gahnite-Spinel series crystal phase include embodiments of composition 22 and 23 in Table 2.

As detailed in the experimental section below, a number of glass-ceramics with a predominant Gahnite-Spinel series crystal phase and a secondary Rutile crystal phase were produced and tested for use as armor components.

A glass composition based on industrial grade raw materials was prepared and 20×20×1 cm glass-ceramic plates produced therefrom using the devitrification regimes described above. Glass-ceramics having a predominant Gahnite-Spinel series crystal phase (molar ratio MgO to ZnO 1:1) and a secondary Rutile crystal phase produced by devitrification according to regimes A, B, C, D, E and F were found to have a hardness of between 12.4 and 15.3 GPa (13.9±10%).

Glass-Ceramic with Predominant Galaxite ((Mn, Fe, Mg)O—(Al, Fe)₂O₃) Crystal Phase

Galaxite ((Mn,Fe,Mg)O—(Al,Fe)₂O₃) is a heterogeneous Spinel type crystal, that is, within the same crystal are found varying proportion MnO, FeO, MgO, Al₂O₃ and Fe₂O₃. In some embodiments of the present invention, a Galaxite crystal phase is primarily a homogenous MnO—Al₂O₃ crystal phase or a heterogeneous (Mn, Mg)O—Al₂O₃ crystal phase. Some embodiments of glass-ceramics of the present invention with a predominant Galaxite crystal phase are produced from devitrification of glass compositions including at least 4%, at least 5%, at least 6% and even at least 9% by weight MgO with MnO and at least 10%, at least 14% or even at least 16% by weight Al₂O₃. The ratio of MgO to MnO is any suitable ratio, where it is understood that in cases where there is a large excess of MgO relative to MnO, the formed Galaxite crystal phase may be accompanied by a homogeneous Spinel crystal phase. Considering that in homogenous Galaxite (MnO—Al₂O₃) the weight ratio of MnO to Al₂O₃ is 1:1.44, some embodiments of glass-ceramics of the present invention with a predominant Galaxite crystal phase are produced from glass having a MnO+MgO to Al₂O₃ weight ratio of between about 1:0.3 and about 1:7.5, between about 1:0.85 and about 1:5 or even between about 1:1.15 and 1:3.

Such glass compositions generally include a nucleating agent, in embodiments TiO₂, in embodiments between 1 and 24% by weight. In embodiments, during devitrification the nucleating agent crystallizes to form a secondary crystal phase of the produced glass-ceramic.

In embodiments a glass composition includes SiO₂. As noted above, SiO₂ is a readily available and cheap material that is a suitable component of a glass composition useful for producing glass-ceramics of the present invention and preferably remains an important component of the glass phase of the produced glass-ceramic.

Embodiments of glass compositions generally include other components that make up a secondary crystal phase or are components of the glass phase of the produced glass-ceramic.

Exemplary glass compositions suitable for production of glass-ceramics of the present invention having a predominant Galaxite crystal phase include embodiments of compositions 14, 17, 24 and 25 in Table 2.

As detailed in the experimental section below, a number of glass-ceramics with a predominant Galaxite crystal phase and a secondary Rutile phase were produced and tested for use as armor components.

A glass composition based on industrial grade raw materials was prepared and 20×20×1 cm glass-ceramic plates produced therefrom using the devitrification regimes described above. Glass-ceramics having a predominant Galaxite crystal phase (molar ratio MgO to MnO 1:1.13) and a secondary Rutile phase produced by devitrification according to regimes A, B, C, D, E and F were found to have a hardness of between 12.9 and 13.1 GPa (13.0±1%).

### Results of Ballistic Tests

The glass-ceramic plates produced as described above including a predominant Spinel crystal phase, a predominant Gahnite-Spinel series crystal phase or a predominant Galaxite crystal phase were provided with a Aramid front spall layer and backing layer and tested in the usual way against ten 7.62×39 PS BU bullets impacting at between 723 m sec⁻¹ and 748 m sec⁻¹ and three 5.56×45 SS-109 bullets impacting at between 942 m sec⁻¹ and 962 m sec⁻¹. No penetration through the glass-ceramic plates was observed. In all cases the obtained results correspond to Level IV protection according to the NIJ 0101.04 standard (formulated and published by the National Institute of Justice of the United States Department of Justice).

Articles of the Present Invention for Protecting an Object from Kinetic Threats

Embodiments of the teachings of the present invention provide for articles useful for protecting an object from kinetic threats and include such objects as armor plates, armor sheets, bullet-proof vests, body armor, protective inserts, panels, door panels, floor panels, wall panels, helmets, seats, roofing elements, tiles, roofing tiles, aircraft, rotary wing aircraft, fixed wing aircraft, armored fighting vehicle, limousines and motor vehicles. Depending on the article, the article consists of, comprises or includes a component that consists of or comprises a glass-ceramic of the present invention.

Generally, a glass-ceramic component is fashioned so as to have an appropriate shape as described above. In embodiments, this is achieved by providing an appropriate glass composition and devitrifying the glass composition in a desired shape as described above.

Once a glass-ceramic component has been provided with the appropriate shape, the glass-ceramic is integrated into the desired article. As is known to those skilled in the art, it is advantageous to associate a glass-ceramic component of an article for protecting a sensitive object from kinetic threats with either or both a front spall layer and a backing layer.

In embodiments, either or both the front spall layer and the backing layer of an article comprise a metal component. Such articles are useful, for example, in vehicular armor implementations. In embodiments, the metal components are thin plates (e.g., no more than 3 mm, no more than 2 mm and even no more than 1 mm thick) of a metal or a metal alloy such as aluminum. In embodiments, a metal component such as a thin plate of aluminum is intimately bonded to an appropriate surface of the glass-ceramic component, for example using an appropriate adhesive (e.g., Dymax 621 Series Multi-Cure® 429 (based on urethane acrylate) or Dymax 4-20586 cationic epoxy both of Dymax Corporation, Torrington Conn., USA)

In embodiments, either or both the front spall layer and the backing layer of an article comprise a textile component. Such articles are useful, for example, as small arms protective inserts or as components of body armor and bulletproof vests. Textiles known as being exceptionally useful for such applications include textiles including fibers of aramid fibers (e.g. Kevlar® (E.I. du Pont de Nemours and Company) and Twaron® (Teijin Twaron B.V., Arnhem, The Netherlands)) or polyethylene fibers (e.g. Dyneema® (Koninklijke DSM N.V., Heerlen, The Netherlands). In embodiments, a textile component is intimately bonded to an appropriate surface of the glass-ceramic component, for example using an appropriate adhesive. In embodiments, the glass-ceramic is encased (e.g., wrapped in or placed inside a pocket) in a textile component, and in embodiments intimately bonded thereto using an appropriate adhesive. An appropriate adhesive is, for example, the sheet adhesive ADP-422-X produced by Polyon-Barkai Industries Ltd., Kibbutz Barkai, Israel that is applied in a vacuum chamber at an elevated temperature.

In embodiments, either or both the front spall layer and the backing layer comprise a non-filamentous semi-crystalline polymer in accordance with the teachings of PCT patent application IL2005/001033 of the Applicant.

Methods of the Present Invention for Protecting an Object from Kinetic Threats

The teachings of the present invention provide for methods of protecting an object from kinetic threats. Such embodiments generally include providing the object with armor comprising a component of an embodiment of a glass-ceramic of the present invention especially when the armor is an article of the present invention as described above.

In embodiments, the object is a building or the like and the armor is used to protect the building or the contents of the building. The object is provided with armor including a component comprising or consisting of an embodiment of a glass-ceramic of the present invention configured for and positioned so as to be suitable for protecting the object from an expected kinetic threat. Such armor includes wall and door panels, tiles and roofing tiles.

In embodiments, the object is a vehicle such as a motor vehicle, a police car, a limousine, a light utility vehicle, a truck or other logistical vehicle, an armor fighting vehicle (e.g., tracked, wheeled, air-cushion) or an aircraft (e.g., fixed wing or rotary wing). The object is provided with armor including a component comprising or consisting of an embodiment of glass-ceramic of the present invention configured for and positioned so as to be suitable for protecting the object from an expected kinetic threat. Such armor includes armor sheets, armor plates, protective inserts, panels, seats and critical component enclosures.

In embodiments, the object is a person. The person is provided with armor including a component comprising or consisting of an embodiment of a glass-ceramic of the present invention configured for and positioned so as to be suitable for protecting the object from an expected kinetic threat. Such armor includes such articles as helmets, body armor or bulletproof vests. Typical components comprising the glass-ceramic are the armor articles self or, for example, a protective insert.

When a kinetic threat, such as a bullet, is projected at the object, the kinetic threat impacts the glass-ceramic component and is neutralized.

A feature of embodiments of articles of the present invention is that these are relatively cheap to manufacture in a desired shape. Since an article or the present invention is often damaged during neutralization of an impacting kinetic threat, in embodiments a glass-ceramic armor component of the present invention is easily replaceable. If the component is damaged, for example due to impact of a kinetic threat, the component is easily replaced. Configuration of armor components for simple replacement and replacements of damaged armor components is well known in the field of armor protection.

### Articles of Manufacture the Present Invention

The teachings of the present invention provide for useful articles that are often made of ceramic or glazed ceramics such as flatware (e.g., plates), hollowware (e.g., bowls, cups, jugs, pitchers), laboratory counter tops, artificial stones, decorative stones, chemical reaction stills, fluid transfer tubing and piping, abrasive resistant liners, table tops, tiles, roofing tiles, sidings, sinks, basins, tubs, souvenirs and curiosities. Depending on the article, the article consists of, comprises or includes a component that consists of or comprises a glass-ceramic of the present invention.

Generally, a glass-ceramic component is fashioned as described above so as to have an appropriate shape. In embodiments, this is achieved by providing an appropriate glass composition and devitrifying the glass composition in a desired shape as described above. Once the glass-ceramic component has the appropriate shape, the glass-ceramic is integrated into the desired article.

As some embodiments of glass-ceramics of the present invention are hard, articles made therefrom are extremely durable. Further, as some embodiments of glass-ceramics of the present invention are relatively cheap to produce, articles produced therefrom are competitively priced.

### EXAMPLES

Reference is now made to the following example that, together with the above description, illustrate the invention in a non-limiting fashion

### Materials, Instruments and Experimental Methods

### Materials:

Coal ash was obtained from the Rutenberg Power Plant (Ashkelon, Israel), the plant burning coal supplied by TotalFinaElf S.A., South Africa and from the United States. The composition of the South African coal ash was SiO₂ (46.4% by weight), Fe₂O₃ (3.7% by weight), Al₂O₃ (31.7% by weight), TiO₂ (1.8% by weight), CaO (8.7% by weight), MgO (2.1% by weight), SO₃ (2.1% by weight), Na₂O (0.3 by weight), P₂O₅ (2.6 by weight), and K₂O (0.6% by weight). The composition of the American coal ash was SiO₂ (58.6% by weight), Fe₂O₃ (9.2% by weight), Al₂O₃ (21.3% by weight), TiO₂ (1.8% by weight), CaO (4.1% by weight), MgO (1.5% by weight), SO₃ (0.6% by weight), Na₂O (0.4 by weight), P₂O₅ (0.3 by weight), and K₂O (2.2% by weight).

Rutile sand was obtained from Richards Bay Iron and Titanium (PTY) Ltd. (Richards Bay, Republic of South Africa). The composition of the Rutile sand was TiO₂ (95% by weight), Fe₂O₃ (0.8% by weight), ZrO₂ (0.85% by weight), P (0.018% by weight), S (0.005% by weight), SiO₂ (1.4% by weight), Al₂O₃ (0.50% by weight), CaO (0.12% by weight), MgO (0.03% by weight), Cr₂O₃ (0.12% by weight), V₂O₅ (0.45% by weight), MnO (0.02% by weight) and Nb₂O₅ (0.30% by weight).

A waste management company supplied a powdered industrial waste. The waste was from a combination of many sources but the waybill accompanying the waste indicated that the waste was composed of SiO₂ (61±3% by weight), Al₂O₃ (32±3% by weight), Fe₂O₃ (˜1% by weight), MgO (˜0.4% by weight), CaO (˜0.6% by weight), TiO₂ (˜1.2% by weight), K₂O (˜2% by weight), Na₂O (4±1% by weight), ZrO₂ (˜0.2% by weight) and Z₂O₃ (˜1% by weight).

Magnesium oxide and Zirconium oxide (99% ZrO₂) were obtained from Refrakem Ltd. in Moshav Kfar Haim, Israel. The composition of the Magnesium oxide was MgO (96.66% by weight), CaO (1.81% by weight), SiO₂ (1.04% by weight), Fe₂O₃ (0.44% by weight) and Al₂O₃ (0.05% by weight). Calcined aluminum oxide Nr. 105 (minimum 99% Al₂O₃) was obtained from Nabaltec GmbH, Schwandorf, Germany.

Industrial grade zinc oxide (99.6% ZnO) was obtained from Numinor Chemical Industries, Maalot, Israel.

Industrial grade silica sand (99% SiO₂) was obtained from Negev Industrial Minerals, Ltd., Omer, Israel.

Manganese oxide (85% MnO, 14% MnO₂) and Cerium oxide (99% CeO₂) was obtained from Chen Samuel Chemicals Ltd., Haifa, Israel.

a. Preparation of Glass-Ceramic Including a Predominant Spinel Crystal Phase from Coal Ash

100 kg South African coal ash, 100 kg American coal ash, 30 kg Rutile sand and 40 kg magnesium oxide were comminuted and mixed together to make a glass composition comprising SiO₂ (39±2% by weight), Al₂O₃ (20±2% by weight), Fe₂O₃ (5±2% by weight), MgO (16±2% by weight), CaO (5±2% by weight), TiO₂ (11±2% by weight) and not more than about 1% each of other minerals.

100 kg of the glass composition mixture was placed in a MG-300 gas-fixed glass-melting furnace (Falorni Glass Furnaces, Empoli, Italy) and heated to and maintained at 900° C. with continuous mixing and the introduction of air for a period of 1 hour to convert residual elemental carbon to volatile CO₂.

After all elemental carbon was volatilized, the glass composition was heated to 1500° C. until a homogenous molten glass composition was produced. The molten glass mixture was poured into a plurality of press molds to form 10 mm thick flat plates of 200 mm×200 mm.

Glass-ceramics of the present invention were produced by devitrification of the molded glass composition in a crystallization oven (Supertherm HT 10/18, Nabertherm GmbH, Neuhausen, Germany) in accordance with the devitrification regimes of the present invention discussed above as detailed below.

Plates prepared according to Regime A were annealed by cooling at a rate of −90° C./hour to a temperature of 700° C. and maintained at the temperature for 3 hours, then cooled at a rate of −90° C./hour to room temperature. When thoroughly cooled, the plates were transferred to the crystallization oven. The plates were heated from room temperature to 800° C. (T1) at a rate of 200° C./h and maintained at 800° C. for 24 hours. Subsequently the plates were heated to 1200° C. (T2) at a rate of 100° C./h and maintained at 1200° C. for 30 hours. Subsequently, the plates were cooled to room temperature at a rate of −60° C./h.

Plates prepared according to Regime B were transferred after casting to the crystallization oven set to 800° C. (T1) and maintained at 800° C. for 24 hours. Subsequently the plates were heated to 1200° C. (T2) at a rate of 100° C./h and maintained at 1200° C. for 30 hours. Subsequently, the plates were cooled to room temperature at a rate of −60° C./h.

Plates prepared according to Regime C were annealed as described above for Regime A. When thoroughly cooled, the plates were transferred to the crystallization oven. The plates were heated from room temperature to 800° C. (T1) at a rate of 200° C./h and maintained at 800° C. for 24 hours. Subsequently the plates were heated to 1050° C. (T2) at a rate of 100° C./h and maintained at 1050° C. for 6 hours. Subsequently the plates were cooled to 800° C. (T3) at a rate of −60° C./h and maintained at 800° C. for 6 hours. Subsequently the plates were heated to 1300° C. (T4) at a rate of 100° C./h and maintained at 1300° C. for 12 hours. Subsequently, the plates were cooled to room temperature at a rate of −60° C./h.

Plates prepared according to Regime D were transferred after casting to the crystallization oven set to 800° C. (T1) and maintained at 800° C. for 24 hours. Subsequently the plates were heated to 1050° C. (T2) at a rate of 100° C./h and maintained at 1050° C. for 6 hours. Subsequently the plates were cooled to 800° C. (T3) at a rate of −60° C./h and maintained at 800° C. for 6 hours. Subsequently the plates were heated to 1300° C. (T4) at a rate of 100° C./h and maintained at 1300° C. for 12 hours. Subsequently, the plates were cooled to room temperature at a rate of −60° C./h.

Plates prepared according to Regime E were annealed as described above for Regime A. When thoroughly cooled, the plates were transferred to the crystallization oven. The plates were heated from room temperature to 800° C. (T1) at a rate of 200° C./h and maintained at 800° C. for 24 hours. Subsequently the plates were heated to 1050° C. (T2) at a rate of 100° C./h and maintained at 1050° C. for 6 hours. Subsequently the plates were cooled to 800° C. (T3) at a rate of −60° C./h and maintained at 800° C. for 6 hours. Subsequently the plates were heated to 1050° C. (T4) at a rate of 100° C./h and maintained at 1050° C. for 12 hours. Subsequently the plates were cooled to 800° C. (T5) at a rate of −60° C./h and maintained at 800° C. for 6 hours. Subsequently the plates were heated to 1300° C. (T6) at a rate of 100° C./h and maintained at 1300° C. for 24 hours. Subsequently, the plates were cooled to room temperature at a rate of −60° C./h.

Plates prepared according to Regime F were annealed as described above for Regime A. When thoroughly cooled, the plates were transferred to the crystallization oven. The plates were heated from room temperature to 800° C. (T1) at a rate of 200° C./h and maintained at 800° C. for 24 hours. Subsequently the plates were heated to 1000° C. (T2) at a rate of 100° C./h and maintained at 1000° C. for 6 hours. Subsequently the plates were cooled to 800° C. (T3) at a rate of −60° C./h and maintained at 800° C. for 6 hours. Subsequently the plates were heated to 1100° C. (T4) at a rate of 100° C./h and maintained at 1100° C. for 12 hours. Subsequently the plates were cooled to 800° C. at a rate of −60° C./h and maintained at 800° C. for 6 hours. Subsequently the plates were heated to 1200° C. (T6) at a rate of 100° C./h and maintained at 1200° C. for 24 hours. Subsequently the plates were cooled to 800° C. (T7) at a rate of −60° C./h and maintained at 800° C. for 6 hours. Subsequently the plates were heated to 1300° C. (T8) at a rate of 100° C./h and maintained at 1300° C. for 12 hours. Subsequently, the plates were cooled to room temperature at a rate of −60° C./h.

The predominant crystal phase in the produced glass-ceramic plates was a substantially homogeneous Spinel phase having relatively significant amounts of Fe₂O₃ and Cr₂O₃ integrated into the Spinel crystals (and thus can also be considered as belonging to the Magnesiochromite-Spinel series (MgO—(Al, Cr)₂O₃) or as a Galaxite (MgO—(Al, Fe)₂O₃)). Also produced was a secondary Rutile phase. The hardness of the plates prepared using devitrification regimes A and B was between 10.0 and 11.7 GPa (Vickers). The hardness of the plates prepared using devitrification regimes C, D, E and F was between 11.1 and 13.2 GPa (Vickers).

b. Preparation of Glass-Ceramic Including a Predominant Spinel Crystal Phase from Industrial Waste

100 kg industrial waste, 15 kg Rutile sand and 20 kg magnesium oxide were comminuted and mixed together to make a glass composition comprising SiO₂ (45±2% by weight), Al₂O₃ (24±2% by weight), MgO (14±2% by weight), TiO₂ (11±2% by weight), Fe₂O₃ (˜1% by weight), CaO (˜1% by weight), K₂O (˜1% by weight), and less than 1% each of other minerals.

Glass-ceramic plates were fashioned from the above glass composition as described in the previous example.

The predominant crystal phase in the produced glass-ceramic plates was a substantially homogeneous Spinel phase including relatively small amounts of Fe₂O₃ integrated into the Spinel crystals (and thus can also be considered as a heterogeneous Galaxite (MgO—(Al,Fe)₂O₃)). Also produced was a secondary Rutile phase. The hardness of the plates prepared using all devitrification regimes was between 13.2 and 13.6 GPa (Vickers).

c. Preparation of Glass-Ceramic Including a Predominant Spinel Crystal Phase from Industrial Grade Raw Materials

100 kg sand, 71 kg alumina, 29 kg magnesium oxide, 34 kg Rutile sand, 5 kg manganese oxide, 3 kg cerium oxide and 5 kg zirconium oxide and were comminuted and mixed together to make a glass composition comprising SiO₂ (41% by weight), Al₂O₃ (29% by weight), CeO₂ (˜1% by weight), MgO (12% by weight), TiO₂ (13% by weight), MnO (2% by weight), ZrO₂ (2% by weight) and less than 1% of other minerals.

Glass-ceramic plates were fashioned from the above glass composition as described in the previous example.

The predominant crystal phase in the produced glass-ceramic plates was a substantially homogeneous Spinel phase having small amounts of MnO integrated into the Spinel crystals (and thus can also be considered as a sort heterogeneous Galaxite ((Mn,Mg)O—Al₂O₃)). Also produced was a secondary Rutile phase. The hardness of the plates prepared using all devitrification regimes was between 14.2 and 16.6 GPa (Vickers).

d. Preparation of Glass-Ceramic Including a Predominant Gahnite-Spinel Series Crystal Phase from Glass Industry Raw Materials

100 kg sand, 41 kg alumina, 20 kg magnesium oxide, 41 kg zinc oxide and 25 kg Rutile sand were comminuted and mixed together to make a glass composition comprising SiO₂ (45% by weight), Al₂O₃ (18% by weight), MgO (9% by weight), ZnO (18% by weight) and TiO₂ (11% by weight) and less than 1% each of other minerals. The molar ratio of MgO to ZnO was 1:1.

Glass-ceramic plates were fashioned from the above glass composition as described in the previous examples where the devitrification regimes were performed at different temperatures. Plates prepared according to Regimes A and B were devitrified at a T1 of 800° C. and T2 of 1100° C. Plates prepared according to Regimes C and D were devitrified at a T1 of 800° C., a T2 of 1050° C., a T3 of 800° C. and a T4 of 1100° C.

The predominant crystal phase in the produced glass-ceramic plates was a heterogeneous Spinel-group crystal phase belonging to the Gahnite-Spinel series ((Zn,Mg)O—Al₂O₃). Also produced was a secondary Rutile phase. The hardness of the plates prepared using all devitrification regimes was between 12.4 and 15.3 GPa (Vickers).

e. Preparation of Glass-Ceramic Including a Predominant Galaxite Crystal Phase from Glass Industry Raw Materials

100 kg sand, 41 kg alumina, 22 kg magnesium oxide, 50 kg manganese oxide and 28 kg Rutile sand were comminuted and mixed together to make a glass composition comprising SiO₂ (42% by weight), Al₂O₃ (17% by weight), MgO (9% by weight), TiO₂ (11% by weight), MnO (18% by weight), MnO₂ (3% by weight) and less than 1% each of other minerals. The molar ratio of MgO to MnO was 1:1.14.

Glass-ceramic plates were fashioned from the above glass composition as described in the previous example.

The predominant crystal phase in the produced glass-ceramic plates was a heterogeneous Galaxite ((Mn,Mg)O—Al₂O₃) crystal phase. Also produced was a secondary Rutile phase. The hardness of the plates prepared using all devitrification regimes was between 12.9 and 13.1 GPa (Vickers).

### Preparation of a Protective Insert

One layer of woven aramid fabric (Twaron® CT microfilament 930 dtex, Teijin Twaron B. V., Arnhem, The Netherlands) was intimately associated with one side and 29 layers were intimately associated with the opposing side of each glass-ceramic plate using adhesive sheets (ADP-422-X produced by Polyon-Barkai Industries Ltd., Kibbutz Barkai, Israel) in a vacuum chamber at between 150° C. and 170° C. for 1 hour so that each plate was completely encased by the aramid fabric, the 1 layer on the strike face of the plate as a spall layer and the 29 layers as a backing layer.

### Ballistic Tests

All the glass-ceramic plates prepared as above were tested in accordance with the NU 0101.04 and shown to effectively neutralize kinetic threats at the IV level. Each plate was found to absorb 13 consecutive hits of 10 7.62×39 PS BU bullets impacting at between 723 m sec⁻¹ and 748 m sec⁻¹ and 3 5.56×45 SS-109 bullets impacting at between 942 m sec⁻¹ and 962 m sec⁻¹. No penetration through the glass-ceramic plates was observed.

Although the invention has been described in conjunction with specific embodiments, it is evident that many alternatives, modifications and variations thereof will be apparent to those skilled in the art. It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination. Accordingly, the present invention is intended to embrace all such alternatives, modifications and variations that fall within the spirit and broad scope of the appended claims.

Although the invention has been described herein with reference to fields relating to defense such as military, paramilitary, law enforcement and civil defense and protection from kinetic threats produced by weapons, the teachings of the present invention are also applicable in other fields where it is desired to protect a sensitive object from a kinetic threat. One such field is space exploration where the teachings of the present invention are applicable for protecting satellites and space exploration vehicles. In such applications the relatively high aerial density and multiple hit neutralization capabilities of protective devices made in accordance with the teachings of the present invention allow protection of satellites and space exploration vehicles from impact with orbiting debris (“space junk”) and micrometeorites.

All publications, patents and patent applications mentioned in this specification are herein incorporated in their entirety by reference into the specification, to the same extent as if each individual publication, patent or patent application was specifically and individually indicated to be incorporated herein by reference. In case of conflict, the specification herein, including definitions, prevails. Citation or identification of any reference in this application shall not be construed as an admission that such reference is available as prior art to the present invention.

1-77. (canceled)

78. A glass-ceramic comprising a glass phase and at least one crystal phase, said at least one crystal phase predominantly comprising Spinel-group crystal phases, said Spinel group crystal phases having the formula XO—Z₂O₃ where X is a divalent metal ion and Z is a trivalent metal ion.

79. A glass-ceramic of claim 78, having a bulk hardness of at least about 11 GPa (Vickers).

80. The glass-ceramic of claim 78, wherein X is selected from the group of divalent metal ions consisting of Mg²⁺, Fe²⁺, Ni²⁺, Mn²⁺, Zn²⁺ and mixtures thereof.

81. The glass-ceramic of claim 78, wherein Z is selected from the group of trivalent metal ions consisting of Al³⁺, Fe³⁺, Cr³⁺, V³⁺, Mn³⁺ and mixtures thereof.

82. The glass-ceramic of claim 78, comprising at least about 4% by weight XO.

83. The glass-ceramic of claim 78, comprising at least about 10% by weight Z₂O₃.

84. The glass-ceramic of claim 78, further comprising TiO₂.

85. The glass-ceramic of claim 78, further comprising SiO₂.

86. An object comprising a glass-ceramic having a bulk hardness of at least about 11 GPa.

87. The object of claim 86, wherein said glass-ceramic comprises divalent metal oxides XO and trivalent metal oxides Z₂O₃.

88. The object of claim 87, wherein said glass-ceramic comprises a glass phase and at least one crystal phase, said at least one crystal phase predominantly comprising Spinel-group crystal phases, said Spinel group crystal phases having the formula XO—Z₂O₃.

89. The object of claim 87, wherein said glass-ceramic comprises at least about 4% by weight said XO.

90. The object of claim 87, wherein said glass-ceramic comprises at least about 10% by weight said Z₂O₃.

91. The object of claim 86, wherein said glass-ceramic comprises TiO₂.

92. The object of claim 86, wherein said glass-ceramic further comprises SiO₂.

93. The object of claim 86, wherein said glass-ceramic comprises:
between 35% and 48% by weight SiO₂;
between 12% and 34% by weight Al₂O₃;
between 9% and 17% by weight MgO; and
between 10% and 18% by weight TiO₂.

94. The object of claim 93, wherein said glass-ceramic has a predominant Spinel crystal phase.

95. The object of claim 86, wherein said glass-ceramic comprises:
between 41% and 47% by weight SiO₂;
between 15% and 21% by weight Al₂O₃;
between 6% and 12% by weight MgO;
between 15% and 21% by weight ZnO; and
between 9% and 13% by weight TiO₂.

96. The object of claim 95, wherein said glass-ceramic has a predominant Gahnite-Spinel series crystal phase.

97. The object of claim 86, wherein said glass-ceramic comprises:
between 41% and t 47% by weight SiO₂;
between 16% and 20% by weight Al₂O₃;
between 8% and 11% by weight MgO;
between 16% and 22% by weight MnO; and
between 9% and 15% by weight TiO₂.

98. The object of claim 97, wherein said glass-ceramic has a predominant Galaxite crystal phase.

99. A method of producing a glass-ceramic, the method comprising:
a. providing a glass composition comprising at least one divalent oxide XO and at least one trivalent oxide Z₂O₃; and
b. devitrifying said glass composition under conditions which lead to the formation of at least one crystal phase suspended in a glass phase so as to constitute the glass-ceramic, said at least one crystal phase predominantly comprising Spinel-group crystal phases, said Spinel group crystal phases having the formula XO—Z₂O₃ where X is a divalent metal ion and Z is a trivalent metal ion.

100. The method of claim 99, wherein said devitrifying comprises:
i. holding said glass composition in an environment maintained at a temperature T1 to provide an incipient glass-ceramic; and
ii. subsequent to i, holding said incipient glass-ceramic in an environment maintained at a temperature T2 substantially higher than T1 thereby leading to formation of said Spinel-group crystal phases.

101. The method of claim 100, said devitrifying further comprising:
iii. subsequent to ii, holding said incipient glass-ceramic in an environment maintained at a temperature T3 substantially lower than T2; and
iv. subsequent to iii, holding said incipient glass-ceramic in an environment maintained at a temperature T4 substantially higher than T3.

102. The method of claim 101, wherein said devitrifying further comprising:
v. subsequent to iv, holding said incipient glass-ceramic composition in an environment maintained at a temperature T5 substantially lower than T4; and
vi. subsequent to v, holding said incipient glass-ceramic in an environment maintained at a temperature T6 substantially higher than T5.

103. The method of claim 102, wherein said denitrifying further comprising:
vii. subsequent to vi, holding said incipient glass-ceramic composition in an environment maintained at a temperature T7 substantially lower than T6; and
viii. subsequent to vii, holding said incipient glass-ceramic in an environment maintained at a temperature T8 substantially higher than T7.

104. The method of claim 99, wherein X0 comprises at least one member of the group consisting of MgO, FeO, NiO, MnO, ZnO and mixtures thereof.

105. The method of claim 99, wherein Z₂O₃ comprises at least one member of the group consisting of Al₂O₃, Mn₂O₃, V₂O₃, Fe₂O₃, Cr₂O₃ and mixtures thereof.

106. The method of claim 99, wherein said glass composition further comprises TiO₂.

107. The method of claim 99, wherein said glass composition further comprises SiO₂.

108. A method of producing a glass-ceramic, the method comprising:
a. providing a glass composition; and
b. devitrifying said glass composition by a process including
i. holding said glass composition in an environment maintained at a temperature T1 to provide an incipient glass-ceramic composition;
ii. subsequent to i, holding said incipient glass-ceramic in an environment maintained at a temperature T2 substantially higher than T1;
iii. subsequent to ii, holding said incipient glass-ceramic composition in an environment maintained at a temperature T3 substantially lower than T2; and
iv. subsequent to iii, holding said incipient glass-ceramic in an environment maintained at a temperature T4 substantially higher than T3 thereby producing the glass-ceramic.

109. The method of claim 108, wherein said devitrifying further comprising:
v. subsequent to iv, holding said incipient glass-ceramic composition in an environment maintained at a temperature T5 substantially lower than T4; and
vi. subsequent to v, holding said incipient glass-ceramic in an environment maintained at a temperature T6 substantially higher than T5.

110. The method of claim 109, wherein said devitrifying further comprising:
vii. subsequent to vi, holding said incipient glass-ceramic composition in an environment maintained at a temperature T7 substantially lower than T6; and
viii. subsequent to vii, holding said incipient glass-ceramic in an environment maintained at a temperature T8 substantially higher than T7.

111. An article of manufacture including a component of a glass-ceramic of claim 78.

112. The article of claim 111, having a shape, said shape selected from the group consisting of flatware, hollowware, laboratory counter tops, artificial stones, decorative stones, chemical reaction stills, fluid transfer tubing and piping, abrasive resistant liners, table tops, tiles, roofing tiles, sidings, sinks, basins, tubs, souvenirs and curiosities.

113. An article for protecting an object from a kinetic threat including a component of a glass-ceramic of claim 78.

114. A method of manufacture of an article for protecting an object from a kinetic threat comprising:
a) providing a component of a glass-ceramic of claim 78; and
b) associating said glass-ceramic component with at least one additional component.
